(19) United States
(12) Patent Application Publication
(10) Pub. No.: US 2022/0004074 A1
(43) Pub. Date: Jan. 6, 2022

(54) OPTICAL MODULATION CONTROL DEVICE AND MACH-ZEHNDER INTERFERENCE DEVICE

(71) Applicant: Mitsubishi Electric Corporation, Tokyo (JP)

(72) Inventors: Hiroshi MIURA, Tokyo (JP); Naoki SUZUKI, Tokyo (JP)

(73) Assignee: Mitsubishi Electric Corporation, Tokyo (JP)

(21) Appl. No.: 17/479,392

(22) Filed: Sep. 20, 2021

Related U.S. Application Data
(63) Continuation of application No. PCT/JP2019/016622, filed on Apr. 18, 2019.

(51) Int. Cl. G02F 1/21; G02F 1/225

(52) U.S. Cl. CPC G02F 1/212; G02F 1/2252

(57) ABSTRACT

An optical modulation control device includes: a photodetector or a photodetector which detects light emitted from a Mach-Zehnder interferometer and outputs an intensity signal indicating intensity of the light; and a phase-bias search unit which searches for and obtains a phase bias when the intensity signal outputted from the photodetector has a local minimum value or a phase bias when the intensity signal outputted from the photodetector has a local maximum value while adjusting a phase bias injected into an optical path inside the Mach-Zehnder interferometer, and records a set of the obtained phase bias and a wavelength of the light.

### CROSS REFERENCE TO RELATED APPLICATIONS

This application is a Continuation of PCT International Application No. PCT/JP2019/016622 filed on Apr. 18, 2019, which is hereby expressly incorporated by reference into the present application.

### TECHNICAL FIELD

The present invention relates to an optical modulation control device and a Mach-Zehnder interference device, which search for a phase bias.

### BACKGROUND ART

In the field of optical fiber communication, a modulator using a modulation scheme such as quadrature amplitude modulation (QAM) is sometimes used for the purpose of improving the transmission capacity per channel.

Non-Patent Literature 1 below discloses a Mach-Zehnder modulator which modulates light emitted from a light source.

In the Mach-Zehnder modulator disclosed in Non-Patent Document 1 below, a semiconductor material such as indium phosphide (InP) is used.

By using a semiconductor material such as InP, the Mach-Zehnder modulator and the light source can be integrated so that the entire device including the Mach-Zehnder modulator and the light source can be downsized.

### CITATION LIST

### Non-Patent Literature

Non-Patent Literature 1: Tetsuya Kawanishi, “High-speed and precise lightwave modulation techniques for ultra high-speed and huge capacity optical transmission,” Japanese journal of optics: publication of the Optical Society of Japan, Vol. 38, No. 5, pp. 246-252, May. 2009.

### SUMMARY OF INVENTION

### Technical Problem

The Mach-Zehnder modulator is a modulator that divides light emitted from a light source into two light beams and outputs the composite light of the divided two light beams, and a modulation signal is superimposed on each of the two divided light beams. In the Mach-Zehnder modulator, the phase difference between the two light beams, on which the modulation signals are superimposed, needs to be kept at 180 degrees. In order to keep the phase difference between the two light beams at 180 degrees, an appropriate bias should be applied to the two light beams, but the appropriate bias varies depending on the wavelength of the light emitted from the light source.

In the Mach-Zehnder modulator disclosed in Non-Patent Literature 1, when the wavelength of the light emitted from the light source changes, a bias for the changed wavelength cannot be generated, so that there is a problem that modulation characteristics may be deteriorated.

The present invention has been made to solve the above-described problem, and an object thereof is to obtain an optical modulation control device and a Mach-Zehnder interference device capable of superimposing a phase bias for wavelength of incident light on the light even when the wavelength of the incident light changes.

### Solution to Problem

An optical modulation control device according to the invention includes: a photodetector to detect light emitted from a Mach-Zehnder interferometer and output an intensity signal indicating the intensity of the light; and a phase-bias searcher to search for and obtain a phase bias when the intensity signal outputted from the photodetector has a local minimum value or a phase bias when the intensity signal has a local maximum value, while adjusting a phase bias injected into an optical path inside the Mach-Zehnder interferometer, and record a set of the obtained phase bias and a wavelength of the light, wherein the phase-bias searcher comprises: a phase-bias adjuster to adjust a phase bias injected into the optical path inside the Mach-Zehnder interferometer; a delayer to keep the intensity signal outputted from the photodetector for a delay time and then output the intensity signal; an amplifier to amplify the intensity signal outputted from the photodetector and output the intensity signal amplified; a comparator to output a differential signal indicating a difference between the intensity signal outputted from the delayer and the intensity signal outputted from the amplifier; and a phase-bias recorder to search for and obtain one or more phase biases when an absolute value of the differential signal outputted from the comparator is smaller than a threshold from among the phase biases injected into the optical path, search for and obtain a smallest intensity signal or a largest intensity signal among intensity signals for the obtained one or more phase biases among the intensity signals outputted from the photodetector, and record a set of a phase bias for the obtained smallest intensity signal and a wavelength of the light or a set of a phase bias for the obtained largest intensity signal and the wavelength of the light.

### Advantageous Effects of Invention

According to the invention, an optical modulation control device includes a phase-bias searcher to search for and obtain a phase bias when an intensity signal outputted from a photodetector has a local minimum value or a phase bias when the intensity signal has a local maximum value, while adjusting the phase bias injected into the optical path inside the Mach-Zehnder interferometer, and record a set of the obtained phase bias and a wavelength of the light. Therefore, the optical modulation control device according to the invention can superimpose the phase bias, which is for the wavelength of the incident light, on the light even if the wavelength of the incident light changes.

### BRIEF DESCRIPTION OF DRAWINGS

FIG. 1 is a configuration diagram illustrating a Mach-Zehnder interference device 2 including an optical modulation control device 5 according to a first embodiment.

FIG. 2 is a hardware configuration diagram illustrating hardware of each of a phase-bias adjustment unit 26, a phase-bias recording unit 27 and a control unit 28 included in the optical modulation control device 5.

FIG. 3 is a hardware configuration diagram of a computer in a case where a part of the optical modulation control device 5 is implemented by software, firmware, or the like.

FIG. 4 is a flowchart illustrating a processing procedure performed in the optical modulation control device 5 at the time of initial setting of an Mach-Zehnder interferometer 4.

FIG. 5 is an explanatory diagram illustrating one example of a relationship between a phase bias I_{φ}(t), which is outputted from the phase-bias adjustment unit 26 to a phase adjustment electrode 15, and an intensity signal I_{PD}(t) outputted from a photodetector 21.

FIG. 6 is an explanatory diagram illustrating a temporal change of the phase bias I_{φ}(t) outputted from the phase-bias adjustment unit 26 to the phase adjustment electrode 15.

FIG. 7 is an explanatory diagram illustrating a temporal change of an intensity signal β(t)·I_{PD}(t) outputted from an amplifier 24.

FIG. 8 is a configuration diagram illustrating a Mach-Zehnder interference device 2 including another optical modulation control device 5 according to the first embodiment.

FIG. 9 is an explanatory diagram illustrating one example of a relationship between the phase bias I_{φ}(t), which is outputted from the phase-bias adjustment unit 26 to the phase adjustment electrode 15, and an intensity signal I_{PD}(t) outputted from a photodetector 29.

FIG. 10 is a configuration diagram illustrating a Mach-Zehnder interference device 2 including an optical modulation control device 5 according to a second embodiment.

FIG. 11 is a configuration diagram illustrating a Mach-Zehnder interference device 2 including an optical modulation control device 5 according to a third embodiment.

FIG. 12 is a configuration diagram illustrating a Mach-Zehnder interference device 2 including an optical modulation control device 5 according to a fourth embodiment.

### DESCRIPTION OF EMBODIMENTS

Hereinafter, in order to explain the present invention in more detail, a mode for carrying out the present invention will be described with reference to the accompanying drawings.

### First Embodiment

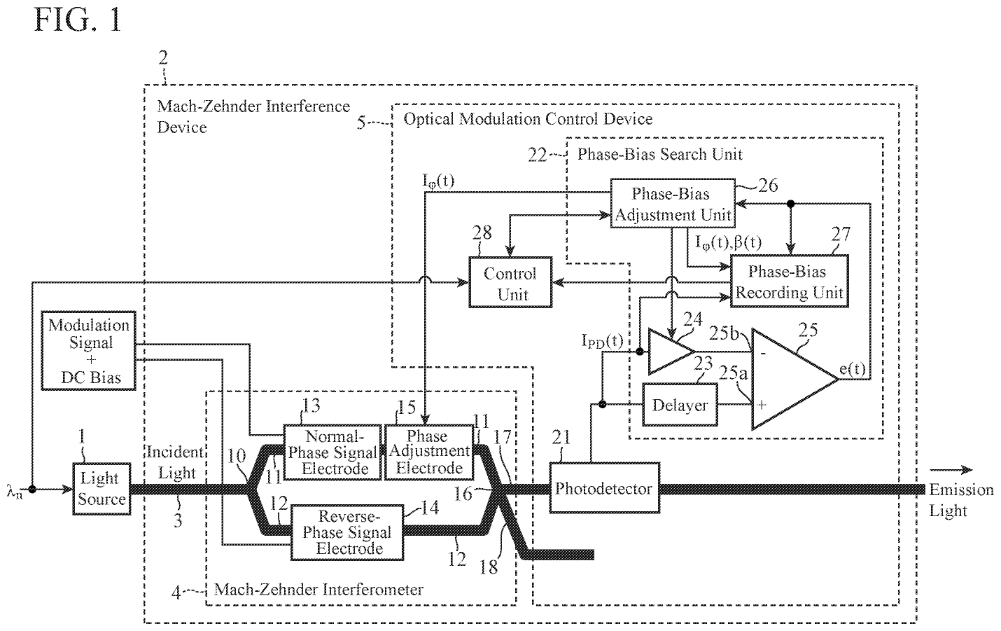

FIG. 1 is a configuration diagram illustrating a Mach-Zehnder interference device 2 including an optical modulation control device 5 according to a first embodiment.

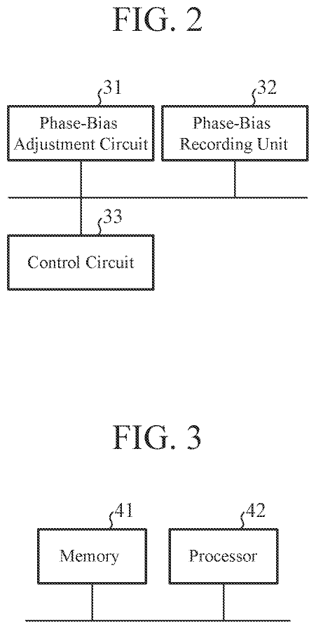

FIG. 2 is a hardware configuration diagram illustrating hardware of each of a phase-bias adjustment unit 26, a phase-bias recording unit 27 and a control unit 28 included in the optical modulation control device 5.

In FIG. 1, a light source 1 is implemented by, for example, a laser diode (LD).

The light source 1 is connected to a Mach-Zehnder interferometer 4 via an optical fiber 3.

The light source 1 emits continuous light to the optical fiber 3 as incident light of the Mach-Zehnder interferometer 4.

The Mach-Zehnder interference device 2 includes the optical fiber 3, the Mach-Zehnder interferometer 4 and the optical modulation control device 5.

The Mach-Zehnder interference device 2 is a device which performs binary phase shift keying (BPSK).

One end of the optical fiber 3 is connected to the light source 1, and the other end of the optical fiber 3 is connected to a branch point 10 of the Mach-Zehnder interferometer 4.

The optical fiber 3 transmits the continuous light emitted from the light source 1 to the branch point 10 of the Mach-Zehnder interferometer 4.

The Mach-Zehnder interferometer 4 includes a first optical path 11, a second optical path 12, a positive-phase signal electrode 13, a negative-phase signal electrode 14, a phase adjustment electrode 15, a first output port 17 and a second output port 18.

Moreover, the Mach-Zehnder interferometer 4 has the branch point 10, which divides incident light into two light beams, and a coupling point 16 which combines the two divided light beams.

The Mach-Zehnder interferometer 4 divides incident light into two light beams at the branch point 10, combines the two divided light beams at the coupling point 16, and emits the composite light of two light beams to a photodetector 21.

The first optical path 11 is an optical path inside the Mach-Zehnder interferometer 4 and implemented by, for example, an optical fiber.

One end of the first optical path 11 is connected to the branch point 10, and the other end of the first optical path 11 is connected to the coupling point 16.

The first optical path 11 transmits one of the two light beams obtained by division at the branch point 10 to the coupling point 16.

The second optical path 12 is an optical path inside the Mach-Zehnder interferometer 4 and implemented by, for example, an optical fiber.

One end of the second optical path 12 is connected to the branch point 10, and the other end of the second optical path 12 is connected to the coupling point 16.

The second optical path 12 transmits the other of the two light beams obtained by division at the branch point 10 to the coupling point 16.

The positive-phase signal electrode 13 is inserted into the first optical path 11.

The positive-phase signal electrode 13 superimposes a DC bias for the wavelength of the incident light on the light transmitted by the first optical path 11. The DC bias may be a direct current or a direct current voltage.

At the time of initial setting of the Mach-Zehnder interferometer 4, the positive-phase signal electrode 13 superimposes only the DC bias on the light and does not superimpose the modulation signal on the light.

During actual operation after the initial setting of the Mach-Zehnder interferometer 4 is completed, the positive-phase signal electrode 13 superimposes both the DC bias and a modulation signal on the light.

The negative-phase signal electrode 14 is inserted into the second optical path 12.

The negative-phase signal electrode 14 superimposes a DC bias for the wavelength of the incident light on the light transmitted by the second optical path 12.

At the time of initial setting of the Mach-Zehnder interferometer 4, the negative-phase signal electrode 14 superimposes only the DC bias on the light and does not superimpose a modulation signal on the light.

During actual operation after the initial setting of the Mach-Zehnder interferometer 4 is completed, the negative-phase signal electrode 14 superimposes both the DC bias and the modulation signal on the light.

The phase adjustment electrode 15 is inserted into the first optical path 11.

The phase adjustment electrode 15 superimposes a phase bias I_{φ}(t), which is outputted from the phase-bias adjustment unit 26, on the light transmitted by the first optical path 11.

In the Mach-Zehnder interference device 2 illustrated in FIG. 1, the phase bias I_{φ}(t) is an electric current, but the phase bias I_{φ}(t) may be a voltage.

The first output port 17 is a port for emitting the composite light to the photodetector 21.

The second output port 18 is a port for emitting light having a reverse phase which is opposite to the composite light. When the intensity of the light emitted from the first output port 17 has the local maximum value, the intensity of the light emitted from the second output port 18 has the local minimum value. Furthermore, when the intensity of the light emitted from the first output port 17 has the local minimum value, the intensity of the light emitted from the second output port 18 has the local maximum value.

In the Mach-Zehnder interference device 2 illustrated in FIG. 1, the light emitted from the second output port 18 is not used.

The optical modulation control device 5 includes the photodetector 21, a phase-bias search unit 22 and the control unit 28.

The photodetector 21 is implemented by, for example, a photodiode.

The photodetector 21 is connected to the first output port 17 of the Mach-Zehnder interferometer 4.

The photodetector 21 detects the composite light emitted from the first output port 17 and outputs an intensity signal I_{PD}(t), which indicates the intensity of the detected composite light, to each of a delayer 23, an amplifier 24 and the phase-bias recording unit 27.

The photodetector 21 also outputs the detected composite light to the outside as emission light.

In the Mach-Zehnder interference device 2 illustrated in FIG. 1, the intensity signal I_{PD}(t) is an electric current, but the intensity signal I_{PD}(t) may be a voltage.

The phase-bias search unit 22 includes the delayer 23, the amplifier 24, a comparator 25, the phase-bias adjustment unit 26 and the phase-bias recording unit 27.

While adjusting the phase bias I_{PD}(t) injected into the first optical path 11 of the Mach-Zehnder interferometer 4, the phase-bias search unit 22 searches for and obtains a phase bias I_{φ}(t)ₘᵢₙ when the intensity signal I_{PD}(t) outputted from the photodetector 21 has the local minimum value.

The phase-bias search unit 22 causes the control unit 28 to record a set of the obtained phase bias I_{φ}(t)ₘᵢₙ and the wavelength of the incident light.

The delayer 23 holds, for a delay time Δt, the intensity signal I_{PD}(t) outputted from the photodetector 21 and outputs an intensity signal I_{PD}(t−Δt) to an input terminal 25a of the comparator 25.

An amplification factor β(t) of the amplifier 24 is adjusted by the phase-bias adjustment unit 26.

The amplifier 24 amplifies the intensity signal I_{PD}(t), which is outputted from the photodetector 21, by the amplification factor β(t) and outputs an amplified intensity signal β(t)·I_{PD}(t) to an inverting input terminal 25b of the comparator 25.

To each of the phase-bias adjustment unit 26 and the phase-bias recording unit 27, the comparator 25 outputs a differential signal e(t) directly proportional to a difference (I_{PD}(t−Δt)−β(t)·I_{PD}(0) between the intensity signal I_{PD}(t−Δt) outputted from the delayer 23 and the intensity signal β(t)·I_{PD}(t) outputted from the amplifier 24.

The phase-bias adjustment unit 26 is implemented by, for example, a phase-bias adjustment circuit 31 illustrated in FIG. 2.

At the time of initial setting of the Mach-Zehnder interferometer 4, the phase-bias adjustment unit 26 adjusts the phase bias I_{φ}(t) outputted to the phase adjustment electrode 15 in accordance with the differential signal e(t) outputted from the comparator 25.

During actual operation of the Mach-Zehnder interferometer 4, the phase-bias adjustment unit 26 outputs the phase bias I_{φ}(t)ₘᵢₙ, which is outputted from the control unit 28, to the phase adjustment electrode 15.

The phase-bias recording unit 27 is implemented by, for example, a phase-bias recording circuit 32 illustrated in FIG. 2.

The phase-bias recording unit 27 searches for and obtains one or more phase biases when the absolute value of the differential signal e(t) outputted from the comparator 25 is smaller than a threshold Th from among the phase biases I_{φ}(t) injected into the first optical path 11.

The phase-bias recording unit 27 searches for and obtains the smallest intensity signal I_{PD}(t)ₘᵢₙ from among the intensity signals I_{PD}(t) for the obtained one or more phase biases I_{φ}(t).

The phase-bias recording unit 27 causes the control unit 28 to record a set of the phase bias I_{φ}(t)ₘᵢₙ, which is for the smallest intensity signal I_{PD}(t)ₘᵢₙ, and the wavelength of the incident light.

The threshold Th is, for example, a value of several [μA], and the threshold Th may be stored in an internal memory of the phase-bias recording unit 27 or may be given from the outside of the Mach-Zehnder interference device 2. Note that the intensity signal I_{PD}(t) is an electric current of several [mA].

In the optical modulation control device 5 illustrated in FIG. 1, the comparator 25 outputs the differential signal e(t) to each of the phase-bias adjustment unit 26 and the phase-bias recording unit 27. However, this is merely an example. The optical modulation control device 5 may include an analog-to-digital converter (Hereinafter, referred to as “A/D converter”) that converts the differential signal e(t), which is outputted from the comparator 25, from an analog signal to a digital signal, and the A/D converter may output the digital signal to each of the phase-bias adjustment unit 26 and the phase-bias recording unit 27.

Since the optical modulation control device 5 illustrated in FIG. 1 includes the A/D converter, the calculation processing of the phase-bias adjustment unit 26, the determination processing of the phase-bias recording unit 27 and the like can be digitally processed.

In a case where the optical modulation control device 5 illustrated in FIG. 1 includes the A/D converter, the phase bias I_{φ}(t) outputted from the phase-bias adjustment unit 26 is a digital signal. Therefore, the optical modulation control device 5 includes a digital-to-analog converter (hereinafter, referred to as a “D/A converter”) that converts the phase bias I_{φ}(t), which is outputted from the phase-bias adjustment unit 26, into an analog signal, and the D/A converter outputs the analog signal to the phase adjustment electrode 15.

The control unit 28 is implemented by, for example, a control circuit 33 illustrated in FIG. 2.

The control unit 28 records a set of the wavelength of the incident light and the phase bias I_{φ}(t)ₘᵢₙ at the time of initial setting of the Mach-Zehnder interferometer 4.

During actual operation of the Mach-Zehnder interferometer 4, the control unit 28 outputs the phase bias I_{φ}(t)ₘᵢₙ, which is for the wavelength, to phase-bias adjustment unit 26.

Each of the phase-bias adjustment unit 26, the phase-bias recording unit 27 and the control unit 28, which are some constituents of the optical modulation control device 5 in FIG. 1 is assumed to be implemented by dedicated hardware as illustrated in FIG. 2. That is, a part of the optical modulation control device 5 is assumed to be implemented by the phase-bias adjustment circuit 31, the phase-bias recording circuit 32 and the control circuit 33.

Herein, each of the phase-bias adjustment circuit 31, the phase-bias recording circuit 32 and the control circuit 33 corresponds to, for example, a single circuit, a composite circuit, a programmed processor, a parallel-programmed processor, an application specific integrated circuit (ASIC), a field-programmable gate array (FPGA), or a combination thereof.

Some constituents of the optical modulation control device 5 are not limited to those implemented by dedicated hardware, and parts of the optical modulation control device 5 may be implemented by software, firmware or a combination of software and firmware.

The software or firmware is stored in a memory of a computer as a program. The computer means hardware that executes a program and corresponds to, for example, a central processing unit (CPU), a central processing device, a processing device, an arithmetic device, a microprocessor, a microcomputer, a processor or a digital signal processor (DSP).

FIG. 3 is a hardware configuration diagram of a computer in a case where some parts of the optical modulation control device 5 are implemented by software, firmware or the like.

In a case where some parts of the optical modulation control device 5 are implemented by software, firmware or the like, a program for causing the computer to execute processing procedures performed in the phase-bias adjustment unit 26, the phase-bias recording unit 27 and the control unit 28 is stored in a memory 41. Then, the processor 42 of the computer executes the program stored in the memory 41.

Moreover, FIG. 2 illustrates an example in which each of some constituents of the optical modulation control device 5 is implemented by dedicated hardware, and FIG. 3 illustrates an example in which some parts of the optical modulation control device 5 are implemented by software, firmware or the like. However, these are merely examples, and some constituents of the optical modulation control device 5 may be implemented by dedicated hardware, and the remaining constituents may be implemented by software, firmware or the like.

Next, the operation of the Mach-Zehnder interference device 2 illustrated in FIG. 1 will be described.

First, the operation of the Mach-Zehnder interferometer 4 at the time of initial setting will be described.

When the modulation signal is not superimposed on the optical path inside the Mach-Zehnder interferometer 4, it is desirable, in terms of modulation characteristics, that the composite light emitted from the first output port 17 of the Mach-Zehnder interferometer 4 is in a state close to zero. Therefore, at the time of initial setting of the Mach-Zehnder interferometer 4, the phase bias I_{φ}(t), in which the composite light emitted from the first output port 17 is in a state close to zero, is obtained.

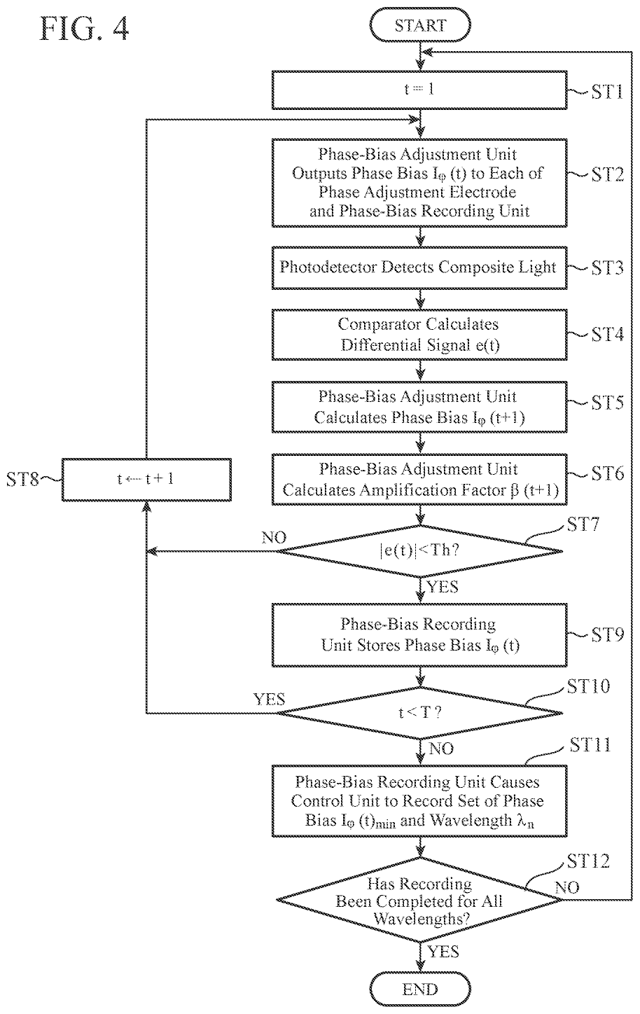

FIG. 4 is a flowchart illustrating a processing procedure performed in the optical modulation control device 5 at the time of initial setting of the Mach-Zehnder interferometer 4.

In the Mach-Zehnder interference device 2 illustrated in FIG. 1, suppose that N wavelengths λ₁ to λ_{N} are likely to be used as wavelengths of incident light of the Mach-Zehnder interferometer 4. N is an integer of two or more.

In the Mach-Zehnder interference device 2 illustrated in FIG. 1, suppose that the DC bias for the wavelength λn (n=1 to N) has a known value.

In the Mach-Zehnder interference device 2 illustrated in FIG. 1, a variable indicating the time is t, and t=0, 1, 2 to T. T is a positive integer.

In the Mach-Zehnder interference device 2 illustrated in FIG. 1, suppose that wavelength information indicating a wavelength λₙ to be used at the time of initial setting among the N wavelengths 21 to λ₁ to λ_{N} is given from the outside to each of the light source 1 and the control unit 28.

The wavelength λₙ indicated by the wavelength information changes every time the phase-bias recording unit 27, which is described later, causes the control unit 28 to record a set of the phase bias I_{φ}(t)ₘᵢₙ and the wavelength λₙ of the incident light.

The light source 1 emits continuous light having a wavelength λₙ indicated by the wavelength information to the optical fiber 3 as incident light of the Mach-Zehnder interferometer 4.

In the Mach-Zehnder interference device 2 illustrated in FIG. 1, the wavelength information is given to each of the light source 1 and the control unit 28 from the outside. However, this is merely an example, and the wavelength λₙ may be selected by a user operating the light source 1.

The optical fiber 3 transmits the continuous light emitted from the light source 1 to the branch point 10 of the Mach-Zehnder interferometer 4.

The Mach-Zehnder interferometer 4 divides incident light, which is the continuous light emitted from the light source 1, into two light beams at the branch point 10.

The first optical path 11 of the Mach-Zehnder interferometer 4 transmits one of the two light beams obtained by division at the branch point 10 to the coupling point 16.

The second optical path 12 of the Mach-Zehnder interferometer 4 transmits the other light beam of the two light beams obtained by division at the branch point 10 to the coupling point 16.

A DC bias for the wavelength λₙ of the continuous light emitted from the light source 1 is applied to each of the positive-phase signal electrode 13 and the negative-phase signal electrode 14.

When the DC bias is applied, the positive-phase signal electrode 13 superimposes the DC bias on the light transmitted by the first optical path 11.

When the DC bias is applied, the negative-phase signal electrode 14 superimposes the DC bias on the light transmitted by the second optical path 12.

In the Mach-Zehnder interference device 2 illustrated in FIG. 1, the DC bias is applied to each of the positive-phase signal electrode 13 and the negative-phase signal electrode 14 from the outside. However, this is merely an example, and the control unit 28 may apply a DC bias for the wavelength λₙ to each of the positive-phase signal electrode 13 and the negative-phase signal electrode 14.

At the time of initial setting of the Mach-Zehnder interferometer 4, each of the positive-phase signal electrode 13 and the negative-phase signal electrode 14 superimposes only the DC bias on the light and does not superimpose a modulation signal on the light.

The control unit 28 initializes the time t to “1” (Step ST1 in FIG. 4).

The phase-bias adjustment unit 26 outputs the phase bias I_{φ}(t) at the time t to each of the phase adjustment electrode 15 and the phase-bias recording unit 27 (Step ST2 in FIG. 4).

Moreover, the phase-bias adjustment unit 26 outputs the amplification factor β(t) at the time t to the phase-bias recording unit 27.

The phase bias I_{φ}(0) when t=0 is stored as an initial value in an internal memory of the phase-bias adjustment unit 26. I_{φ}(0) is, for example, 0 [mA].

For example, the phase bias I_{φ}(1) at time t=1 is calculated from the phase bias I_{φ}(0) in accordance with the following formula (2) described later.

The amplification factor β(0) at t=0 is stored as an initial value in the internal memory of the phase-bias adjustment unit 26. The amplification factor β(0) is, for example, one.

For example, the amplification ratio β(1) at time t=1 is calculated from the amplification factor β(0) in accordance with the following formula (3) described later.

The phase adjustment electrode 15 superimposes the phase bias I_{φ}(t), which is outputted from the phase-bias adjustment unit 26, on the light transmitted by the first optical path 11.

The Mach-Zehnder interferometer 4 combines one light beam transmitted by the first optical path 11 and the other light beam transmitted by the second optical path 12 at the coupling point 16.

From the first output port 17 to the photodetector 21, the Mach-Zehnder interferometer 4 emits the composite light of the two light beams combined at the coupling point 16.

The photodetector 21 detects the composite light emitted from the first output port 17 (Step ST3 in FIG. 4).

To each of the delayer 23, the amplifier 24 and the phase-bias recording unit 27, the photodetector 21 outputs an intensity signal I_{PD}(t) indicating the intensity of the detected composite light.

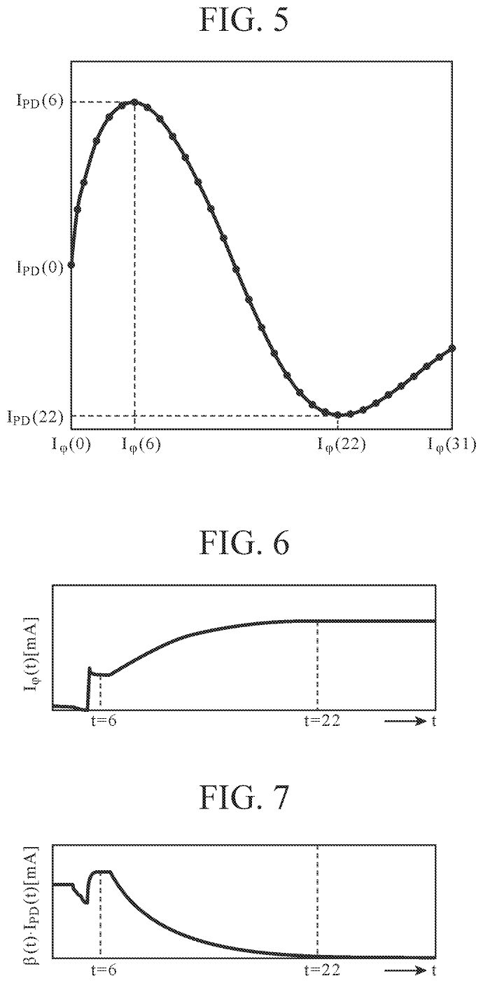

FIG. 5 is an explanatory diagram illustrating one example of a relationship between the phase bias I_{φ}(t), which is outputted from the phase-bias adjustment unit 26 to the phase adjustment electrode 15, and the intensity signal I_{PD}(t), which is outputted from the photodetector 21.

In the example in FIG. 5, T=31, and the intensity signal I_{PD}(t) has the local maximum value at the phase bias I_{φ}(6) at t=6, and the intensity signal I_{PD}(t) has the local minimum value at the phase bias I_{φ}(22) at t=22.

FIG. 6 is an explanatory diagram illustrating a temporal change of the phase bias I_{φ}(t) outputted from the phase-bias adjustment unit 26 to the phase adjustment electrode 15.

When receiving the intensity signal I_{PD}(t) from the photodetector 21, the delayer 23 holds the intensity signal I_{PD}(t) for a delay time Δt. The delay time Δt is equal to a time difference between the time t and the time t−1.

The delayer 23 outputs the intensity signal I_{PD}(t) held for the delay time Δt to the input terminal 25a of the comparator 25 as the intensity signal I_{PD}(t−Δt).

The amplifier 24 acquires the amplification factor β(t) outputted from the phase-bias adjustment unit 26.

Once received intensity signal I_{PD}(t) from the photodetector 21, the amplifier 24 amplifies the intensity signal I_{PD}(t) by the amplification factor β(t) and outputs the amplified intensity signal β(t)·I_{PD}(t) to the inverting input terminal 25b of the comparator 25.

FIG. 7 is an explanatory diagram illustrating a temporal change of the intensity signal β(t)·I_{PD}(t) outputted from the amplifier 24.

The intensity signal β(t)·I_{PD}(t) outputted from the amplifier 24 changes as shown in FIG. 7 with the lapse of time.

The comparator 25 acquires the intensity signal I_{PD}(t−Δt) from the delayer 23 and acquires the intensity signal β(t)·I_{PD}(t) from the amplifier 24.

As shown in the following formula (1), the comparator 25 calculates a differential signal e(t) directly proportional to the difference (I_{PD} (t−Δt)−β(t)·I_{PD}(t)) between the intensity signal I_{PD} (t−Δt) and the intensity signal (β(t)·I_{PD} (t) (Step ST4 in FIG. 4).

e(t)=α(I_{PD}(t−Δt)−β(t)·I_{PD}(0)) (1)

In the formula (1), α is a positive constant.

The comparator 25 outputs the calculated differential signal e(t) to each of the phase-bias adjustment unit 26 and the phase-bias recording unit 27.

Once received the differential signal e(t) from the comparator 25, the phase-bias adjustment unit 26 calculates the phase bias I_{φ}(t+1) at time t+1 by adding the differential signal e(t) to the phase bias I_{φ}(t) as shown in the following formula (2) (Step ST5 in FIG. 4).

The phase-bias adjustment unit 26 outputs the calculated phase bias I_{φ}(t+1) to the phase adjustment electrode 15.

I_{φ}(t+1)=e(t)+I₁₀₀(t) (2)

The phase bias I_{φ}(t) adjusted by the phase-bias adjustment unit 26 changes as shown in FIG. 6 with the lapse of time t.

Moreover, the phase-bias adjustment unit 26 calculates an amplification factor β(t+1) at time t+1 on the basis of the differential signal e(t) as shown in the following equation (3) (Step ST6 in FIG. 4).

$$β ( t + 1 ) = β ( t ) - \frac{e ( t )}{10 \vert e ( t ) \vert} \qquad ( 3 )$$

When the differential signal e(t) is positive, the amplification factor β(t+1) decreases more than the amplification factor β(t), and when the differential signal e(t) is negative, the amplification factor β(t+1) increases more than the amplification factor β(t).

The phase-bias adjustment unit 26 outputs the calculated amplification factor β(t+1) to each of the amplifier 24 and the phase-bias recording unit 27.

Once received the differential signal e(t) from the comparator 25, the phase-bias recording unit 27 determines whether or not the absolute value of the differential signal e(t) is smaller than the threshold Th as shown in the following formula (4) (Step ST7 in FIG. 4).

|e(t)|<Th (4)

In a case where the relationship between the phase bias I_{φ}(t) and the intensity signal I_{PD}(t) is expressed as shown in FIG. 5, when the absolute value of the differential signal e(t) is smaller than the threshold Th, there is a high possibility that the intensity signal I_{PD}(t) outputted from the photodetector 21 has the local maximum value or the local minimum value.

When the intensity signal I_{PD}(t) has the extreme value, as shown in FIG. 5, the difference between I_{PD} (t−1) and I_{PD} (t) is smaller than when the intensity signal I_{PD}(t) has a value other than the extreme value.

When the absolute value of the differential signal e(t) is smaller than the threshold Th (Step ST7: YES in FIG. 4), there is a high possibility that the intensity signal I_{PD}(t) has a local maximum value or a local minimum value. Thus, the phase-bias recording unit 27 saves each of the intensity signal I_{PD}(t) and the phase bias I_{φ}(t) in the internal memory (Step ST9 in FIG. 4).

In the example of FIG. 5, a set of the intensity signal I_{PD}(6) and the phase bias I_{φ}(6) and a set of the intensity signal I_{PD}(22) and the phase bias I_{φ}(22) are stored in the internal memory of the phase-bias recording unit 27.

Since the intensity signal β(t)·I_{PD}(t) outputted from the amplifier 24 has the local minimum value around t=4 as shown in FIG. 7, there is a possibility that a set of the intensity signal I_{PD} (4) and the phase bias I_{φ}(4) is saved in the internal memory of the phase-bias recording unit 27. However, since the intensity signal I_{PD}(4) outputted from the photodetector 21 does not have the local minimum value as shown in FIG. 5, the set of the intensity signal I_{PD}(4) and the phase bias I_{φ}(4) is erroneously saved.

The control unit 28 determines whether or not the time t is T (Step ST10 in FIG. 4).

When the time t is smaller than T (Step ST10 in FIG. 4: YES), the control unit 28 increments the time t by 1 (Step ST8 in FIG. 4).

Also when the absolute value of the differential signal e(t) is equal to or greater than the threshold Th (Step ST7 in FIG. 4: NO), the control unit 28 increments the time t by 1 (Step ST8 in FIG. 4).

Thereafter, the processing of Steps ST2 to ST10 is repeated until the time t reaches T (Step ST10 in FIG. 4: NO).

When the time t reaches T, the phase-bias recording unit 27 compares one or more intensity signals I_{PD}(t) saved in the internal memory with each other and searches for and obtains the smallest intensity signal I_{PD}(t)ₘᵢₙ.

For example, in a case where the intensity signal I_{PD}(4), the intensity signal I_{PD}(6) and the intensity signal I_{PD}(22) are saved, as shown in FIG. 5, since the intensity signal I_{PD}(22) is the smallest, the intensity signal I_{PD}(22) is obtained for as the smallest intensity signal I_{PD}(t)ₘᵢₙ.

After searching for and obtaining the smallest intensity signal I_{PD}(t)ₘᵢₙ, the phase-bias recording unit 27 causes the control unit 28 to record a set of the phase bias I_{φ}(t)ₘᵢₙ for intensity signal I_{PD}(t)ₘᵢₙ and the wavelength λₙ of the incident light (Step ST11 in FIG. 4).

When the intensity signal I_{PD}(22) is obtained as the intensity signal I_{PD}(t)ₘᵢₙ, a set of the phase bias I_{φ}(22) and the wavelength λₙ is recorded in the control unit 28.

Herein, the phase-bias recording unit 27 causes the control unit 28 to record a set of the phase bias I_{φ}(t)ₘᵢₙ and the wavelength λₙ. However, this is merely an example, and the phase-bias recording unit 27 may cause the control unit 28 to record a set of the phase bias I_{φ}(t)ₘᵢₙ, the wavelength λₙ and the DC bias.

In a case where a set of the phase bias I_{φ}(t)ₘᵢₙ, the wavelength λₙ, and the DC bias is recorded by the control unit 28, the control unit 28 can output the DC bias for the wavelength λₙ to each of the positive-phase signal electrode 13 and the negative-phase signal electrode 14 at the time of actual operation of the Mach-Zehnder interferometer 4.

The phase-bias search unit 22 determines whether or not the recording of the phase bias I_{φ}(t)ₘᵢₙ has been completed for all the N wavelengths λₙ (Step ST12 in FIG. 4).

When the recording of the phase bias I_{φ}(t)ₘᵢₙ has been completed for all of the N wavelengths λₙ (Step ST12 in FIG. 4: YES), the operation at the time of initial setting of the Mach-Zehnder interferometer 4 ends.

When there remains a wavelength λₙ for which recording of the phase bias I_{φ}(t) n has not been completed among the N wavelengths λₙ (Step ST12 in FIG. 4: NO), the processing of Steps ST1 to ST12 is repeated.

Next, the operation of the Mach-Zehnder interferometer 4 during actual operation will be described.

In the Mach-Zehnder interference device 2 illustrated in FIG. 1, suppose that wavelength information indicating a wavelength λₙ to be used in actual operation among the N wavelengths λ₁ to λ_{N} is given to the light source 1 and the control unit 28.

The light source 1 emits continuous light having a wavelength λₙ indicated by the wavelength information to the optical fiber 3 as incident light of the Mach-Zehnder interferometer 4.

A DC bias for the wavelength λₙ of the continuous light emitted from the light source 1 is applied to each of the positive-phase signal electrode 13 and the negative-phase signal electrode 14.

When the DC bias is applied, the positive-phase signal electrode 13 superimposes both the DC bias and the modulation signal on the light transmitted by the first optical path 11.

When the DC bias is applied, the negative-phase signal electrode 14 superimposes both the DC bias and the modulation signal on the light transmitted by the second optical path 12.

The control unit 28 acquires the phase bias I_{φ}(t)ₘᵢₙ for the wavelength λₙ indicated by the wavelength information from among the phase biases I_{φ}(t)ₘᵢₙ for N wavelengths λ₁ to λ_{N} recorded at the time of initial setting.

The control unit 28 outputs the acquired phase bias I_{φ}(t)ₘᵢₙ to the phase-bias adjustment unit 26.

The phase-bias adjustment unit 26 outputs the phase bias I_{φ}(t)ₘᵢₙ, which is outputted from the control unit 28, to the phase adjustment electrode 15.

The phase adjustment electrode 15 superimposes the phase bias I_{φ}(t)ₘᵢₙ, which is outputted from the phase-bias adjustment unit 26, on the light transmitted by the first optical path 11.

The photodetector 21 detects the composite light emitted from the first output port 17 and outputs the detected composite light to the outside as emission light.

The Mach-Zehnder interference device 2 shown in FIG. 1 includes the photodetector 21 which detects the composite light emitted from the first output port 17 of the Mach-Zehnder interferometer 4.

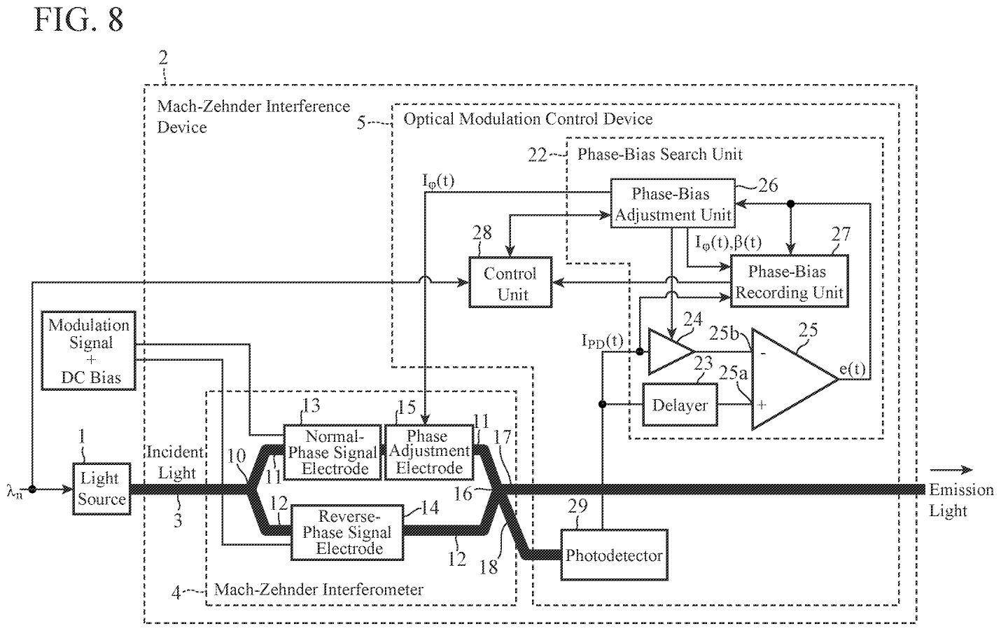

However, this is merely an example, and as shown in FIG. 8, the Mach-Zehnder interference device 2 may include a photodetector 29 which detects the composite light emitted from the second output port 18 of the Mach-Zehnder interferometer 4.

FIG. 8 is a configuration diagram illustrating a Mach-Zehnder interference device 2 including another optical modulation control device 5 according to the first embodiment. In FIG. 8, the same reference signs as those in FIG. 1 denote the same or corresponding parts, and thus description thereof is omitted.

The photodetector 29 is implemented by, for example, a photodiode.

The photodetector 29 is connected to the second output port 18 of the Mach-Zehnder interferometer 4.

The photodetector 29 detects the composite light emitted from the second output port 18 and outputs an intensity signal I_{PD}(t), which indicates the intensity of the detected composite light, to each of the delayer 23, the amplifier 24 and the phase-bias recording unit 27.

The second output port 18 is a port for emitting light having a phase opposite to that of the composite light emitted from the first output port 17.

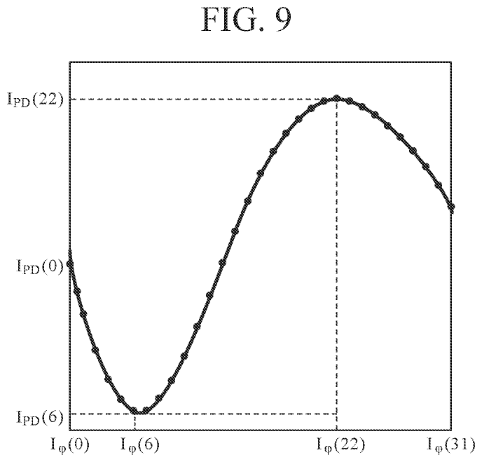

Therefore, the relationship between the phase bias I_{φ}(t), which is outputted from the phase-bias adjustment unit 26 to the phase adjustment electrode 15, and the intensity signal I_{PD}(t), which is outputted from the photodetector 29, is expressed as illustrated in FIG. 9.

FIG. 9 is an explanatory diagram illustrating one example of a relationship between the phase bias I_{φ}(t), which is outputted from the phase-bias adjustment unit 26 to the phase adjustment electrode 15, and the intensity signal I_{PD}(t), which is outputted from the photodetector 29.

The waveform illustrated in FIG. 9 is compared with the waveform illustrated in FIG. 5. In the waveform illustrated in FIG. 5, the intensity signal I_{PD}(t) first reaches the local maximum value and then reaches the local minimum value, but in the waveform illustrated in FIG. 9, the intensity signal I_{PD}(t) first reaches the local minimum value and then reaches the local maximum value.

In the example of FIG. 9, T=31, and the intensity signal I_{PD}(t) has the local minimum value at the phase bias I_{φ}(6) at t=6, and the intensity signal I_{PD}(t) has the local maximum value at the phase bias I_{φ}(22) at t=22.

Unlike the phase-bias search unit 22 illustrated in FIG. 1, the phase-bias search unit 22 illustrated in FIG. 8 searches for and obtains the phase bias I_{φ}(t)ₘₐₓ when the intensity signal I_{PD}(t) outputted from the photodetector 29 has the local maximum value from the phase bias I_{φ}(t) injected into the first optical path 11.

The phase-bias search unit 22 causes the control unit 28 to record a set of the obtained phase bias I_{φ}(t)ₘₐₓ and the wavelength λₙ of the incident light.

Specifically, similar to the phase-bias recording unit 27 illustrated in FIG. 1, when the absolute value of the differential signal e(t) is smaller than the threshold Th, the phase-bias recording unit 27 illustrated in FIG. 8 saves each of the intensity signal I_{PD}(t) and the phase bias I_{φ}(t) in the internal memory.

Unlike the phase-bias recording unit 27 illustrated in FIG. 1, when the time t is T, the phase-bias recording unit 27 illustrated in FIG. 8 compares one or more intensity signals I_{PD}(t) saved in the internal memory with each other to search for and obtain the largest intensity signal I_{PD}(t)ₘₐₓ.

For example, in a case where the intensity signal I_{PD}(4), the intensity signal I_{PD}(6) and the intensity signal I_{PD}(22) are saved, as shown in FIG. 9, since the intensity signal I_{PD}(22) is the largest, the intensity signal I_{PD}(22) is obtained for as the largest intensity signal I_{PD}(t)ₘₐₓ.

After searching for and obtaining the largest intensity signal I_{PD}(t)ₘₐₓ, the phase-bias recording unit 27 causes the control unit 28 to record a set of the phase bias I_{φ}(t)ₘₐₓ for the intensity signal I_{PD}(t)ₘₐₓ and the wavelength λₙ of the incident light.

When the intensity signal I_{φ}(22) is obtained as the intensity signal I_{PD}(t)ₘₐₓ, a set of the phase bias I_{φ}(22) and the wavelength λₙ is recorded by the control unit 28.

The phase bias I_{φ}(t)ₘₐₓ recorded by the phase-bias recording unit 27 illustrated in FIG. 8 and the phase bias I_{φ}(t)ₘᵢₙ recorded by the phase-bias recording unit 27 illustrated in FIG. 1 are the same phase bias I_{φ}(22).

Therefore, the Mach-Zehnder interference device 2 illustrated in FIG. 1 and the Mach-Zehnder interference device 2 illustrated in FIG. 8 obtain the same result.

In the first embodiment described above, the optical modulation control device 5 includes the photodetector 21 or the photodetector 29, which detects the light emitted from the Mach-Zehnder interferometer 4 and outputs the intensity signal indicating the intensity of the light, and the phase-bias search unit 22 which searches for and obtains the phase bias when the intensity signal outputted from the photodetector 21 reaches the local minimum value or the phase bias when the intensity signal outputted from the photodetector 29 reaches the local maximum value while adjusting the phase bias injected into the optical path inside the Mach-Zehnder interferometer 4, and records a set of the obtained phase bias and the wavelength of the light. Therefore, the optical modulation control device 5 can superimpose the phase bias, which is for the wavelength of the incident light, on the light even if the wavelength of the incident light changes.

The optical modulation control device 5 illustrated in FIG. 1 causes the control unit 28 to record a set of the phase bias I_{φ}(t)ₘᵢₙ and the wavelength λₙ of the incident light when the intensity signal I_{PD}(t) outputted from the photodetector 21 has the local minimum value.

Moreover, the optical modulation control device 5 illustrated in FIG. 8 causes the control unit 28 to record a set of the phase bias I_{φ}(t)ₘₐₓ and the wavelength λₙ of the incident light when the intensity signal I_{PD}(t) outputted from the photodetector 29 has the local maximum value.

However, these are merely examples. In addition to the set of the phase bias I_{φ}(t)ₘᵢₙ and the wavelength λₙ of the incident light when the intensity signal I_{PD}(t) outputted from the photodetector 21 has the local minimum value, the optical modulation control device 5 shown in FIG. 1 may cause the control unit 28 to record a set of the phase bias I_{φ}(t)ₘₐₓ and the wavelength λₙ of incident light when the intensity signal I_{PD} (t) has the local maximum value.

Moreover, in addition to the set of the phase bias I_{φ}(t)ₘₐₓ and the wavelength λₙ of the incident light when the intensity signal I_{PD}(t) outputted from the photodetector 29 has the local maximum value, the optical modulation control device 5 shown in FIG. 8 may cause the control unit 28 to record a set of the phase bias I_{φ}(t)ₘᵢₙ and the wavelength λₙ of incident light when the intensity signal I_{PD} (t) has the local minimum value.

In the optical modulation control device 5 illustrated in FIGS. 1 and 8, when the absolute value of the differential signal e(t) is smaller than the threshold Th, the phase-bias recording unit 27 saves each of the intensity signal I_{PD}(t) and the phase bias I_{φ}(t) in the internal memory. However, this is merely an example. The phase-bias recording unit 27 may save each of the intensity signal I_{PD}(t) and the phase bias I_{φ}(t) at all times t (t=1 to N) in the internal memory.

In a case where the phase-bias recording unit 27 saves each of the intensity signal I_{PD}(t) and the phase bias I_{φ}(t) at all times t, when the absolute value of the differential signal e(t) is smaller than the threshold Th, an internal memory having a larger capacity is required than a case where each of the intensity signal I_{PD}(t) and the phase bias I_{φ}(t) is saved. However, in a case where the phase-bias recording unit 27 saves each of the intensity signal I_{PD}(t) and the phase bias I_{φ}(t) at all times t, each of the delayer 23, the amplifier 24 and the comparator 25 is unnecessary, and the configuration of the optical modulation control device 5 can be simplified.

### Second Embodiment

In the optical modulation control device 5 shown in FIG. 1, the phase-bias adjustment unit 26 adjusts the phase bias I_{φ}(t) injected into the first optical path 11.

In a second embodiment, an optical modulation control device 5 is described in which a phase-bias adjustment unit 26 adjusts both a phase bias I_{φ+}(t) injected into a first optical path 11 and a phase bias I_{φ-}(t) injected into a second optical path 12.

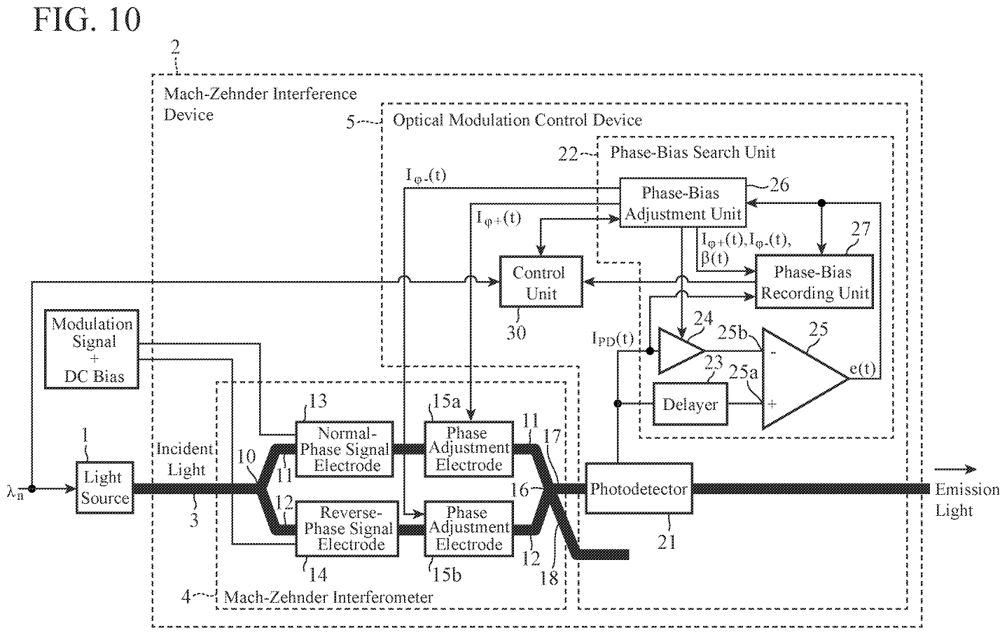

FIG. 10 is a configuration diagram illustrating a Mach-Zehnder interference device 2 including the optical modulation control device 5 according to the second embodiment. In FIG. 10, the same reference signs as those in FIG. 1 denote the same or corresponding parts.

In the optical modulation control device 5 illustrated in FIG. 10, a photodetector 21 detects composite light emitted from a first output port 17 of a Mach-Zehnder interferometer 4. Instead of the photodetector 21, the optical modulation control device 5 may include a photodetector 29 which detects the composite light emitted from a second output port 18 of the Mach-Zehnder interferometer 4.

A phase adjustment electrode 15a is inserted into the first optical path 11 similarly to the phase adjustment electrode 15 illustrated in FIG. 1.

The phase adjustment electrode 15a superimposes a phase bias I_{φ+}(t), which is outputted from the phase-bias adjustment unit 26, on the light transmitted by the first optical path 11.

The phase adjustment electrode 15a superimposes the phase bias I_{φ+}(t) on the light transmitted by the first optical path 11 so that the phase of the light transmitted by the first optical path 11 is rotated to the positive side.

A phase adjustment electrode 15b is inserted into the second optical path 12.

The phase adjustment electrode 15b superimposes a phase bias I_{φ-}(t), which is outputted from the phase-bias adjustment unit 26, on the light transmitted by the second optical path 12.

The phase adjustment electrode 15b superimposes the phase bias I_{φ-}(t) on the light transmitted by the second optical path 12 so that the phase of the light transmitted by the second optical path 12 is rotated to the negative side.

The rotation direction of the phase of the light transmitted by the first optical path 11 and the rotation direction of the phase of the light transmitted by the second optical path 12 are opposite directions. However, since the absolute value of the phase bias I_{φ+}(t) and the absolute value of the phase bias I_{φ-}(t) are the same, the rotation amount of the phase of the light transmitted by the first optical path 11 and the rotation amount of the phase of the light transmitted by the second optical path 12 are the same.

Note that the identity herein is not limited to an exact match and may be shifted within a scope where there is no practical problem.

The operation of a phase-bias search unit 22 illustrated in FIG. 10 is generally similar to the operation of the phase-bias search unit 22 illustrated in FIG. 1. However, unlike the phase-bias adjustment unit 26 illustrated in FIG. 1, the phase-bias adjustment unit 26 illustrated in FIG. 10 outputs the phase bias I_{φ+}(t) to the phase adjustment electrode 15a and outputs the phase bias I_{φ-}(t) to the phase adjustment electrode 15b.

Furthermore, the phase-bias adjustment unit 26 illustrated in FIG. 10 outputs each of the phase bias I_{φ+}(t), the phase bias I_{φ-}(t) and the amplification factor β(t) to the phase-bias recording unit 27.

The phase-bias adjustment unit 26 illustrated in FIG. 10 calculates the phase bias I_{φ}(t+1) at time t+1 by adding the differential signal e(t) to the phase bias LAO as expressed by the following formula (5).

I_{φ+}(t+1)=e(t)+I_{φ+}(t) (5)

The phase-bias adjustment unit 26 illustrated in FIG. 10 calculates the phase bias I_{φ-}(t+1) at time t+1 as expressed in the following formula (6).

I_{φ-}(t+1)=−I_{φ+}(t+1) (6)

When the phase-bias adjustment unit 26 illustrated in FIG. 10 outputs the phase bias I_{φ+}(t) to the phase adjustment electrode 15a and outputs the phase bias I_{φ-}(t) to the phase adjustment electrode 15b and |I_{φ}(t)|=|I_{φ+}(t)|=|I_{φ-}(t)|, the phase rotation amount is doubled as compared with the case where the phase bias I_{φ}(t) is outputted to the phase adjustment electrode 15 as illustrated in FIG. 1.

Since the phase rotation amount is doubled, the dynamic range in the phase control can be doubled from the case where the phase bias I_{φ}(t) is outputted to the phase adjustment electrode 15.

Since the phase rotation amount is doubled, the phase-bias adjustment unit 26 may calculate the amplification factor β(t+1) at the time t+1 as expressed in the following formula (7).

$$β ( t + 1 ) = β ( t ) - \frac{e ( t )}{20 \vert e ( t ) \vert} \qquad ( 7 )$$

In the denominator of the second term on the right side in formula (7), the constant multiplied by |e(t)| is 20, and in Formula (3), it is twice the constant “10” multiplied by |e(t)|.

Therefore, the increase or decrease of the amplification factor β(t+1) at the time t+1 is smaller than the case where the phase bias I_{φ}(t) is outputted to the phase adjustment electrode 15 as illustrated in FIG. 1.

### Third Embodiment

In the Mach-Zehnder interference device 2 of the first and second embodiments, BPSK is performed.

In a third embodiment, a Mach-Zehnder interference device 2 that performs quadrature phase shift keying (QPSK) will be described.

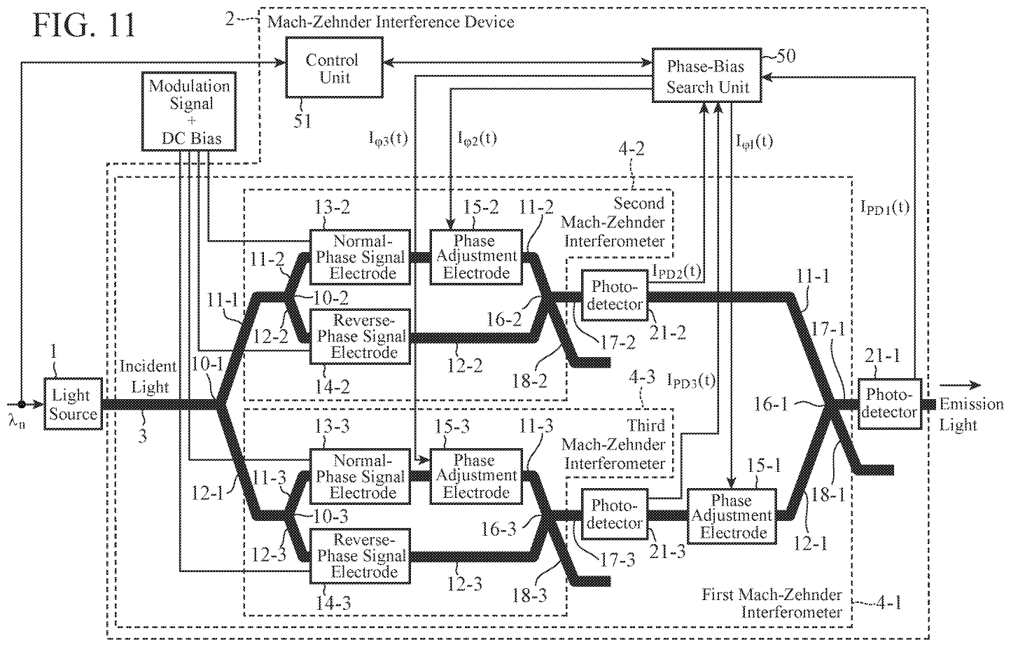

FIG. 11 is a configuration diagram illustrating the Mach-Zehnder interference device 2 including an optical modulation control device 5 according to the third embodiment. In FIG. 11, the same reference signs as those in FIG. 1 denote the same or corresponding parts, and thus description thereof is omitted.

A first Mach-Zehnder interferometer 4-1 includes a second Mach-Zehnder interferometer 4-2 and a third Mach-Zehnder interferometer 4-3.

The first Mach-Zehnder interferometer 4-1 includes a first optical path 11-1, a second optical path 12-1, photodetectors 21-2 and 21-3, a phase adjustment electrode 15-1, a first output port 17-1 and a second output port 18-1.

Moreover, the first Mach-Zehnder interferometer 4-1 has a branch point 10-1 which divides incident light into two light beams, and a coupling point 16-1 which combines the two divided light beams.

The first Mach-Zehnder interferometer 4-1 divides incident light into two light beams at the branch point 10-1, combines the two divided light beams at the coupling point 16-1, and emits the composite light of the two light beams to a photodetector 21-1.

The first optical path 11-1 is implemented by, for example, an optical fiber.

One end of the first optical path 11-1 is connected to the branch point 10-1, and the other end of the first optical path 11-1 is connected to the coupling point 16-1.

The first optical path 11-1 transmits one of the two light beams obtained by division at the branch point 10-1 to the coupling point 16-1 via the second Mach-Zehnder interferometer 4-2.

The second optical path 12-1 is implemented by, for example, an optical fiber.

One end of the second optical path 12-1 is connected to the branch point 10-1, and the other end of the second optical path 12-1 is connected to the coupling point 16-1.

The second optical path 12-1 transmits the other of the two light beams obtained by division at the branch point 10-1 to the coupling point 16-1 via the third Mach-Zehnder interferometer 4-3.

A phase adjustment electrode 15-1 is inserted into the second optical path 12-1.

The phase adjustment electrode 15-1 superimposes the phase bias I_{φ1}(t), which is outputted from a phase-bias search unit 50, on the light transmitted by the second optical path 12-1.

The first output port 17-1 is a port for emitting the composite light to the photodetector 21-1.

The second output port 18-1 is a port for emitting light having a phase opposite to that of the composite light.

In the Mach-Zehnder interference device 2 illustrated in FIG. 11, light emitted from the second output port 18-1 is not used.

A second Mach-Zehnder interferometer 4-2 includes a first optical path 11-2, a second optical path 12-2, a positive-phase signal electrode 13-2, a negative-phase signal electrode 14-2, a phase adjustment electrode 15-2, a first output port 17-2 and a second output port 18-2.

Moreover, the second Mach-Zehnder interferometer 4-2 has a branch point 10-2, which divides incident light into two light beams, and a coupling point 16-2, which combines the two divided light beams.

The second Mach-Zehnder interferometer 4-2 divides incident light into two light beams at the branch point 10-2, combines the two divided light beams at the coupling point 16-2, and emits the composite light of the two light beams to the photodetector 21-2.

The positive-phase signal electrode 13-2 is inserted into the first optical path 11-2.

The positive-phase signal electrode 13-2 superimposes a DC bias, which is for the wavelength of the incident light, on the light transmitted by the first optical path 11-2.

At the time of initial setting of the second Mach-Zehnder interferometer 4-2, the positive-phase signal electrode 13-2 superimposes only the DC bias on the light and does not superimpose the modulation signal on the light.

During actual operation after the initial setting of the second Mach-Zehnder interferometer 4-2 is completed, the positive-phase signal electrode 13-2 superimposes both the DC bias and the modulation signal on the light.

The negative-phase signal electrode 14-2 is inserted into the second optical path 12-2.

The negative-phase signal electrode 14-2 superimposes a DC bias, which is for wavelength of the incident light, on the light transmitted by the second optical path 12-2.

At the time of initial setting of the second Mach-Zehnder interferometer 4-2, the negative-phase signal electrode 14-2 superimposes only the DC bias on the light and does not superimpose the modulation signal on the light.

During actual operation after the initial setting of the second Mach-Zehnder interferometer 4-2 is completed, the negative-phase signal electrode 14-2 superimposes both the DC bias and the modulation signal on the light.

The phase adjustment electrode 15-2 is inserted into the first optical path 11-2.

The phase adjustment electrode 15-2 superimposes the phase bias I_{φ2}(t), which is outputted from the phase-bias search unit 50, on the light transmitted by the first optical path 11-2.

The first output port 17-2 is a port for emitting the composite light to the photodetector 21-2.

The second output port 18-2 is a port for emitting light having a phase opposite to that of the composite light.

In the Mach-Zehnder interference device 2 illustrated in FIG. 11, light emitted from the second output port 18-2 is not used.

The third Mach-Zehnder interferometer 4-3 includes a first optical path 11-3, a second optical path 12-3, a positive-phase signal electrode 13-3, a negative-phase signal electrode 14-3, a phase adjustment electrode 15-3, a first output port 17-3 and a second output port 18-3.

Moreover, the third Mach-Zehnder interferometer 4-3 has a branch point 10-3, which divides incident light into two light beams, and a coupling point 16-3, which combines the two divided light beams.

The third Mach-Zehnder interferometer 4-3 divides incident light into two light beams at the branch point 10-3, combines the two divided light beams at the coupling point 16-3, and emits the composite light of two light beams to the photodetector 21-3.

The positive-phase signal electrode 13-3 is inserted into the first optical path 11-3.

The positive-phase signal electrode 13-3 superimposes a DC bias, which is for the wavelength of the incident light, on the light transmitted by the first optical path 11-3.

At the time of initial setting of the third Mach-Zehnder interferometer 4-3, the positive-phase signal electrode 13-3 superimposes only the DC bias on the light and does not superimpose the modulation signal on the light.

During actual operation after the initial setting of the third Mach-Zehnder interferometer 4-3 is completed, the positive-phase signal electrode 13-3 superimposes both the DC bias and the modulation signal on the light.

The negative-phase signal electrode 14-3 is inserted into the second optical path 12-3.

The negative-phase signal electrode 14-3 superimposes a DC bias, which is for the wavelength of the incident light, on the light transmitted by the second optical path 12-3.

At the time of initial setting of the third Mach-Zehnder interferometer 4-3, the negative-phase signal electrode 14-3 superimposes only the DC bias on the light and does not superimpose the modulation signal on the light.

During actual operation after the initial setting of the third Mach-Zehnder interferometer 4-3 is completed, the negative-phase signal electrode 14-3 superimposes both the DC bias and the modulation signal on the light.

The phase adjustment electrode 15-3 is inserted into the first optical path 11-3.

The phase adjustment electrode 15-3 superimposes the phase bias I_{φ3}(t), which is outputted from the phase-bias search unit 50, on the light transmitted by the first optical path 11-3.

The first output port 17-3 is a port for emitting the composite light to the photodetector 21-3.

The second output port 18-3 is a port for emitting light having a phase opposite to that of the composite light.

In the Mach-Zehnder interference device 2 illustrated in FIG. 11, light emitted from the second output port 18-3 is not used.

The photodetector 21-2 is implemented by, for example, a photodiode.

The photodetector 21-2 is connected to the first output port 17-2 of the second Mach-Zehnder interferometer 4-2.

The photodetector 21-2 detects the composite light emitted from the first output port 17-2 and outputs a second intensity signal I_{PD2}(t), which indicates the intensity of the detected composite light, to the phase-bias search unit 50.

The photodetector 21-2 also outputs the detected composite light to the first optical path 11-1.

The photodetector 21-3 is implemented by, for example, a photodiode.

The photodetector 21-3 is connected to the first output port 17-3 of the third Mach-Zehnder interferometer 4-3.

The photodetector 21-3 detects the composite light emitted from the first output port 17-3 and outputs a third intensity signal I_{PD3}(t), which indicates the intensity of the detected composite light, to the phase-bias search unit 50.

Moreover, the photodetector 21-3 outputs the detected composite light to the phase adjustment electrode 15-1.

The photodetector 21-1 is implemented by, for example, a photodiode.

The photodetector 21-1 is connected to the first output port 17-1 of the first Mach-Zehnder interferometer 4-1.

The photodetector 21-1 detects the composite light emitted from the first output port 17-1 and outputs a first intensity signal I_{PD1}(t), which indicates the intensity of the detected composite light, to the phase-bias search unit 50.

The photodetector 21-1 also outputs the detected composite light to the outside as emission light.

While adjusting the phase bias I_{φ2}(t) injected into the first optical path 11-2 of the second Mach-Zehnder interferometer 4-2, the phase-bias search unit 50 searches for and obtains the phase bias I_{φ2}(t)ₘᵢₙ when the second intensity signal I_{PD2}(t) outputted from the photodetector 21-2 has the local minimum value.

The phase-bias search unit 50 causes a control unit 51 to record a set of the obtained phase bias I_{φ2}(t)ₘᵢₙ and the wavelength λₙ of the incident light.

While adjusting the phase bias I_{φ3}(t) injected into the first optical path 11-3 of the third Mach-Zehnder interferometer 4-3, the phase-bias search unit 50 searches for and obtains the phase bias I_{φ3}(t)ₘᵢₙ when the third intensity signal I_{PD3}(t) outputted from the photodetector 21-3 has the local minimum value.

The phase-bias search unit 50 causes the control unit 51 to record a set of the obtained phase bias I_{φ3}(t)ₘᵢₙ and the wavelength λₙ of the incident light.

While adjusting the phase bias I_{φ1}(t) injected into the second optical path 12-1 of the first Mach-Zehnder interferometer 4-1, the phase-bias search unit 50 searches for and obtains the phase bias I_{φ1}(t)_{mid} which is half the sum of the phase bias I_{φ1}(t)ₘᵢₙ and the phase bias I_{φ1}(t)ₘₐₓ. The phase bias I_{φ1}(t)ₘᵢₙ is a phase bias when the first intensity signal I_{PD1}(t) outputted from the photodetector 21-1 has the local minimum value, and the phase bias I_{φ1}(t)ₘₐₓ is a phase bias when the first intensity signal I_{PD1}(t) has the local maximum value.

The phase-bias search unit 50 causes the control unit 51 to record a set of the obtained phase bias I_{φ1}(t)_{mid} and the wavelength λₙ of the incident light.

The control unit 51 records a set of the wavelength λₙ of the incident light, the phase bias 42(t)ₘᵢₙ, the phase bias I_{φ3}(t)ₘᵢₙ and the phase bias I_{φ1}(t)_{mid}.

During actual operation of the first Mach-Zehnder interferometer 4-1, the control unit 51 outputs the phase bias I_{φ2}(t)_{mid}, which is for the wavelength λₙ, to the phase-bias search unit 50.

During actual operation of the second Mach-Zehnder interferometer 4-2, the control unit 51 outputs the phase bias I_{φ3}(t)ₘᵢₙ, which is for the wavelength λₙ, to the phase-bias search unit 50.

During actual operation of the third Mach-Zehnder interferometer 4-3, the control unit 51 outputs the phase bias I_{φ3}(t)ₘᵢₙ, which is for the wavelength λₙ, to the phase-bias search unit 50.

Next, the operation of the Mach-Zehnder interference device 2 illustrated in FIG. 11 will be described.

First, operations at the time of initial setting of the first Mach-Zehnder interferometer 4-1, the second Mach-Zehnder interferometer 4-2, and the third Mach-Zehnder interferometer 4-3 will be described.

In the Mach-Zehnder interference device 2 illustrated in FIG. 11, suppose that wavelength information indicating a wavelength λₙ to be used at the time of initial setting among the N wavelengths λ₁ to λ_{N} is given from the outside to each of the light source 1 and the control unit 28.

The wavelength λₙ indicated by the wavelength information changes every time the phase-bias search unit 50, which is described later, causes the control unit 51 to record a set of the wavelength λₙ of the incident light, the phase bias I_{φ2}(t)ₘᵢₙ, the phase bias I_{φ3}(t)ₘᵢₙ and the phase bias I_{φ1}(t)_{mid}.

The light source 1 emits continuous light, which has a wavelength λₙ indicated by the wavelength information, to the optical fiber 3 as incident light of the first Mach-Zehnder interferometer 4-1.

The optical fiber 3 transmits the continuous light emitted from the light source 1 to the branch point 10-1 of the first Mach-Zehnder interferometer 4-1.

The first Mach-Zehnder interferometer 4-1 divides incident light, which is the continuous light emitted from the light source 1, into two light beams at the branch point 10-1.

The first optical path 11-1 of the first Mach-Zehnder interferometer 4-1 transmits one of the two light beams obtained by division at the branch point 10-1 to the branch point 10-2 of the second Mach-Zehnder interferometer 4-2.

The second optical path 12-1 of the first Mach-Zehnder interferometer 4-1 transmits the other of the two light beams obtained by division at the branch point 10-1 to the branch point 10-3 of the third Mach-Zehnder interferometer 4-3.

The second Mach-Zehnder interferometer 4-2 divides the light transmitted by the first optical path 11-1 into two light beams at the branch point 10-2.

The first optical path 11-2 of the second Mach-Zehnder interferometer 4-2 transmits one of the two light beams obtained by division at the branch point 10-2 to the coupling point 16-2.

The second optical path 12-2 of the second Mach-Zehnder interferometer 4-2 transmits the other of the two light beams obtained by division at the branch point 10-2 to the coupling point 16-2.

A DC bias for the wavelength λₙ of the continuous light emitted from the light source 1 is applied to each of the positive-phase signal electrode 13-2 and the negative-phase signal electrode 14-2.

When the DC bias is applied, the positive-phase signal electrode 13-2 superimposes the DC bias on the light transmitted by the first optical path 11-2.

When the DC bias is applied, the negative-phase signal electrode 14-2 superimposes the DC bias on the light transmitted by the second optical path 12-2.

The phase adjustment electrode 15-2 superimposes the phase bias I_{φ2}(t), which is outputted from the phase-bias search unit 50, on the light transmitted by the first optical path 11-2.

The third Mach-Zehnder interferometer 4-3 divides the light transmitted by the second optical path 12-1 into two light beams at the branch point 10-3.

The first optical path 11-3 of the third Mach-Zehnder interferometer 4-3 transmits one of the two light beams obtained by division at the branch point 10-3 to the coupling point 16-3.

The second optical path 12-3 of the third Mach-Zehnder interferometer 4-3 transmits the other of the two light beams obtained by division at the branch point 10-3 to the coupling point 16-3.

A DC bias for the wavelength λₙ of the continuous light emitted from the light source 1 is applied to each of the positive-phase signal electrode 13-3 and the negative-phase signal electrode 14-3.

When the DC bias is applied, the positive-phase signal electrode 13-3 superimposes the DC bias on the light transmitted by the first optical path 11-3.

When the DC bias is applied, the negative-phase signal electrode 14-3 superimposes the DC bias on the light transmitted by the second optical path 12-3.

The phase adjustment electrode 15-3 superimposes the phase bias I_{φ3}(t), which is outputted from the phase-bias search unit 50, on the light transmitted by the first optical path 11-3.

The photodetector 21-2 detects the composite light emitted from the first output port 17-2 of the second Mach-Zehnder interferometer 4-2.

The photodetector 21-2 outputs the second intensity signal I_{PD2}(t), which indicates the intensity of the detected composite light, to the phase-bias search unit 50.

The photodetector 21-3 detects the composite light emitted from the first output port 17-3 of the third Mach-Zehnder interferometer 4-3.

The photodetector 21-3 outputs a third intensity signal I_{PD3}(t), which indicates the intensity of the detected composite light, to the phase-bias search unit 50.

While adjusting the phase bias I_{φ2}(t) injected into the first optical path 11-2 of the second Mach-Zehnder interferometer 4-2, the phase-bias search unit 50 searches for and obtains the phase bias I_{φ2}(t)ₘᵢₙ when the second intensity signal I_{PD2}(t) outputted from the photodetector 21-2 has the local minimum value.

Since a method of searching for and obtaining the phase bias I_{φ2}(t)ₘᵢₙ when the second intensity signal I_{PD2}(t) has the local minimum value is similar to that of the phase-bias search unit 22 shown in FIG. 1, the detailed description thereof is omitted.

The phase-bias search unit 50 causes the control unit 51 to record a set of the obtained phase bias I_{φ2} (t)ₘᵢₙ and the wavelength λₙ of the incident light.

While adjusting the phase bias I_{φ3}(t) injected into the first optical path 11-3 of the third Mach-Zehnder interferometer 4-3, the phase-bias search unit 50 searches for and obtains the phase bias I_{φ3}(t)ₘᵢₙ when the third intensity signal I_{PD3}(t) outputted from the photodetector 21-3 has the local minimum value.

Since a method of searching for and obtaining the phase bias I_{PD3}(t)ₘᵢₙ when the third intensity signal I_{PD3}(t) has the local minimum value is similar to that of the phase-bias search unit 22 illustrated in FIG. 1, the detailed description thereof is omitted.

The phase-bias search unit 50 causes the control unit 51 to record a set of the obtained phase bias I_{φ3}(t)ₘᵢₙ and the wavelength λₙ of the incident light.

While adjusting the phase bias I_{φ1}(t) injected into the second optical path 12-1 of the first Mach-Zehnder interferometer 4-1, the phase-bias search unit 50 searches for and obtains the phase bias I_{φ1}(t)ₘᵢₙ when the first intensity signal I_{PD1}(t) outputted from the photodetector 21-1 has the local minimum value.

The phase-bias search unit 50 temporarily saves the phase bias I_{φ1}(t)ₘᵢₙ when the first intensity signal I_{PD1}(t) has the local minimum value.

While adjusting the phase bias I_{φ1}(t) injected into the second optical path 12-1 of the first Mach-Zehnder interferometer 4-1, the phase-bias search unit 50 searches for and obtains the phase bias I_{φ1}(t)ₘₐₓ when the first intensity signal I_{PD1}(t) outputted from the photodetector 21-1 has the local maximum value.

The phase-bias search unit 50 temporarily saves the phase bias I_{φ1}(t)ₘₐₓ when the first intensity signal I_{PD1}(t) has the local maximum value.

The phase-bias search unit 50 calculates the phase bias I_{φ1}(t)_{mid}, which is half the sum of the temporarily saved phase bias I_{φ1}(t)ₘᵢₙ and the temporarily saved phase bias I_{φ1}(t)ₘₐₓ as expressed in the following formula (8).

$${{I}_{∅ 1} ( t )}_{mid} = \frac{{{I}_{∅ 1} ( t )}_{min} + {{I}_{∅ 1} ( t )}_{max}}{2} \qquad ( 8 )$$

The phase-bias search unit 50 causes the control unit 51 to record a set of the calculated phase bias I_{φ1}(t)_{mid} and the wavelength λₙ of the incident light.

Next, operations during actual operations of the first Mach-Zehnder interferometer 4-1, the second Mach-Zehnder interferometer 4-2 and the third Mach-Zehnder interferometer 4-3 will be described.

In the Mach-Zehnder interference device 2 shown in FIG. 11, suppose that wavelength information indicating a wavelength λₙ to be used in actual operation among the N wavelengths λ₁ to λ_{N} is applied to the light source 1 and the control unit 51.

The light source 1 emits continuous light, which has a wavelength λₙ indicated by the wavelength information, to the optical fiber 3 as incident light of the first Mach-Zehnder interferometer 4-1.

A DC bias for the wavelength λₙ of the continuous light emitted from the light source 1 is applied to each of the positive-phase signal electrodes 13-2 and 13-3 and the negative-phase signal electrodes 14-2 and 14-3.

When the DC bias is applied, the positive-phase signal electrode 13-2 superimposes both the DC bias and the modulation signal on the light transmitted by the first optical path 11-2.

When the DC bias is applied, the positive-phase signal electrode 13-3 superimposes both the DC bias and the modulation signal on the light transmitted by the first optical path 11-3.

When the DC bias is applied, the negative-phase signal electrode 14-2 superimposes both the DC bias and the modulation signal on the light transmitted by the second optical path 12-2.

When the DC bias is applied, the negative-phase signal electrode 14-3 superimposes both the DC bias and the modulation signal on the light transmitted by the second optical path 12-3.

The control unit 51 acquires the phase bias I_{φ1}(t)_{mid} for the wavelength λₙ indicated by the wavelength information, the phase bias I_{φ2}(t)ₘᵢₙ for the wavelength λₙ, and the phase bias I_{φ3}(t)ₘᵢₙ for the wavelength λₙ from among the phase biases for the N wavelengths λ₁ to λ_{N} recorded at the time of initial setting.

The control unit 51 outputs the phase bias I_{φ1}(t)_{mid}, the phase bias I_{φ2}(t)ₘᵢₙ and the phase bias I_{φ3}(t)ₘᵢₙ to the phase-bias search unit 50.

The phase-bias search unit 50 outputs the phase bias I_{φ2}(t)ₘᵢₙ outputted from the control unit 51 to the phase adjustment electrode 15-2, and outputs the phase bias I_{φ3}(t)ₘᵢₙ outputted from the control unit 51 to the phase adjustment electrode 15-3.

The phase-bias search unit 50 also outputs the phase bias I_{φ1}(t)_{mid}, which is outputted from the control unit 51, to the phase adjustment electrode 15-1.

The phase adjustment electrode 15-2 superimposes the phase bias I_{φ2}(t)ₘᵢₙ, which is outputted from the phase-bias search unit 50, on the light transmitted by the first optical path 11-2.

The photodetector 21-2 detects the composite light emitted from the first output port 17-2 of the second Mach-Zehnder interferometer 4-2 and outputs the detected composite light to the coupling point 16-1.

The phase adjustment electrode 15-3 superimposes the phase bias I_{φ3}(t)ₘᵢₙ, which is outputted from the phase-bias search unit 50, on the light transmitted by the first optical path 11-3.

The photodetector 21-3 detects the composite light emitted from the first output port 17-3 of the third Mach-Zehnder interferometer 4-3 and outputs the detected composite light to the phase adjustment electrode 15-1.

The phase adjustment electrode 15-1 superimposes the phase bias I_{φ1}(t)_{mid}, which is outputted from the phase-bias search unit 50, on the light outputted from the photodetector 21-3.

The photodetector 21-1 detects the composite light emitted from the first output port 17-1 of the first Mach-Zehnder interferometer 4-1 and outputs the detected composite light to the outside as emission light.

As described above, even in the Mach-Zehnder interference device 2 which performs QPSK, the phase bias for the wavelength of the incident light can be superimposed on the light even if the wavelength of the incident light changes, as in the Mach-Zehnder interference device 2 illustrated in FIG. 1.

In the Mach-Zehnder interference device 2 illustrated in FIG. 11, the photodetector 21-2 detects the composite light emitted from the first output port 17-2 of the second Mach-Zehnder interferometer 4-2, and the photodetector 21-3 detects the composite light emitted from the first output port 17-3 of the third Mach-Zehnder interferometer 4-3. Moreover, the photodetector 21-1 detects the composite light emitted from the first output port 17-1 of the first Mach-Zehnder interferometer 4-1.

However, this is merely an example. The photodetector 21-2 may detect the composite light emitted from the second output port 18-2 of the second Mach-Zehnder interferometer 4-2, and the photodetector 21-3 may detect the composite light emitted from the second output port 18-3 of the third Mach-Zehnder interferometer 4-3. Furthermore, the photodetector 21-1 may detect the composite light emitted from the second output port 18-1 of the first Mach-Zehnder interferometer 4-1. In this case, while adjusting the phase bias I_{φ2}(t) injected into the first optical path 11-2 of the second Mach-Zehnder interferometer 4-2, the phase-bias search unit 50 searches for and obtains the phase bias I_{φ2}(t)ₘₐₓ when the second intensity signal I_{PD2}(t) outputted from the photodetector 21-2 has the local maximum value. Moreover, while adjusting the phase bias I_{φ3}(t) injected into the first optical path 11-3 of the third Mach-Zehnder interferometer 4-3, the phase-bias search unit 50 searches for and obtains the phase bias I_{φ3}(t)ₘₐₓ when the third intensity signal I_{PD3}(t) outputted from the photodetector 21-3 has the local maximum value.

While adjusting the phase bias I_{φ1}(t) injected into the second optical path 12-1 of the first Mach-Zehnder interferometer 4-1, the phase-bias search unit 50 searches for and obtains the phase bias I_{φ1}(t)_{mid} which is half the sum of the phase bias I_{φ1}(t)ₘᵢₙ and the phase bias I_{φ1}(t)ₘₐₓ. The phase bias I_{φ1}(t)ₘᵢₙ is a phase bias when the first intensity signal I_{PD1}(t) outputted from the photodetector 21-1 has the local minimum value, and the phase bias I_{φ1}(t)ₘₐₓ is a phase bias when the first intensity signal I_{PD1}(t) has the local maximum value.

### Fourth Embodiment

In a fourth embodiment, a Mach-Zehnder interference device 2 which performs double polarization QPSK (hereinafter referred to as “DP-QPSK”) will be described.

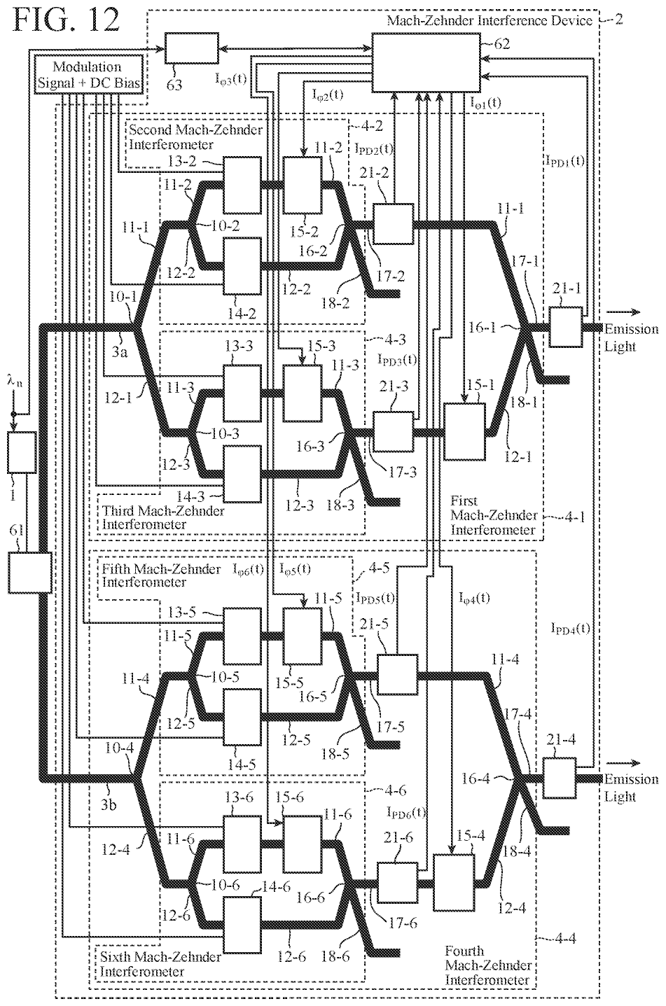

FIG. 12 is a configuration diagram illustrating the Mach-Zehnder interference device 2 including an optical modulation control device 5 according to the fourth embodiment. In FIG. 12, the same reference signs as those in FIGS. 1 and 11 denote the same or corresponding parts, and thus description thereof is omitted.

A splitter 61 splits continuous light emitted from a light source 1 into an X-polarized wave (first polarized wave) and a Y-polarized wave (second polarized wave), outputs the X-polarized wave to a first Mach-Zehnder interferometer 4-1 via an optical fiber 3a, and outputs the Y-polarized wave to a fourth Mach-Zehnder interferometer 4-4 via an optical fiber 3b.

One end of the optical fiber 3a is connected to the splitter 61, and the other end of the optical fiber 3a is connected to a branch point 10-1 of the first Mach-Zehnder interferometer 4-1.

One end of the optical fiber 3b is connected to the splitter 61, and the other end of the optical fiber 3b is connected to a branch point 10-4 of the fourth Mach-Zehnder interferometer 4-4.

The fourth Mach-Zehnder interferometer 4-4 includes a fifth Mach-Zehnder interferometer 4-5 and a sixth Mach-Zehnder interferometer 4-6.

The fourth Mach-Zehnder interferometer 4-4 includes a first optical path 11-4, a second optical path 12-4, photodetectors 21-5 and 21-6, a phase adjustment electrode 15-4, a first output port 17-4 and a second output port 18-4.

Moreover, the fourth Mach-Zehnder interferometer 4-4 has a branch point 10-4, which divides incident light into two light beams, and a coupling point 16-4, which combines the two divided light beams.

The fourth Mach-Zehnder interferometer 4-4 divides incident light into two light beams at the branch point 10-4, combines the two divided light beams at the coupling point 16-4, and emits the composite light of the two light beams to a photodetector 21-4.

The first optical path 11-4 is implemented by, for example, an optical fiber.

One end of the first optical path 11-4 is connected to the branch point 10-4, and the other end of the first optical path 11-4 is connected to the coupling point 16-4.

The first optical path 11-4 transmits one of the two light beams obtained by division at the branch point 10-4 to the coupling point 16-4 via the fifth Mach-Zehnder interferometer 4-5.

The second optical path 12-4 is implemented by, for example, an optical fiber.

One end of the second optical path 12-4 is connected to the branch point 10-4, and the other end of the second optical path 12-4 is connected to the coupling point 16-4.

The second optical path 12-4 transmits the other of the two light beams obtained by division at the branch point 10-4 to the coupling point 16-4 via the sixth Mach-Zehnder interferometer 4-6.

The phase adjustment electrode 15-4 is inserted into the second optical path 12-4.

The phase adjustment electrode 15-4 superimposes the phase bias I_{φ4}(t), which is outputted from a phase-bias search unit 62, on the light transmitted by the second optical path 12-4.

The first output port 17-4 is a port for emitting the composite light to the photodetector 21-4.

The second output port 18-4 is a port for emitting light having a phase opposite to that of the composite light.

In the Mach-Zehnder interference device 2 illustrated in FIG. 12, light emitted from the second output port 18-4 is not used.

The fifth Mach-Zehnder interferometer 4-5 includes a first optical path 11-5, a second optical path 12-5, a positive-phase signal electrode 13-5, a negative-phase signal electrode 14-5, a phase adjustment electrode 15-5, a first output port 17-5 and a second output port 18-5.

Moreover, the fifth Mach-Zehnder interferometer 4-5 has a branch point 10-5, which divides incident light into two light beams, and a coupling point 16-5, which combines the two divided light beams.

The fifth Mach-Zehnder interferometer 4-5 divides incident light into two light beams at the branch point 10-5, combines the two divided light beams at the coupling point 16-5, and emits the composite light of the two light beams to the photodetector 21-5.

The positive-phase signal electrode 13-5 is inserted into the first optical path 11-5.

The positive-phase signal electrode 13-5 superimposes a DC bias, which is for the wavelength of the incident light, on the light transmitted by the first optical path 11-5.

At the time of initial setting of the fifth Mach-Zehnder interferometer 4-5, the positive-phase signal electrode 13-5 superimposes only the DC bias on the light and does not superimpose the modulation signal on the light.

During actual operation after the initial setting of the fifth Mach-Zehnder interferometer 4-5 is completed, the positive-phase signal electrode 13-5 superimposes both the DC bias and the modulation signal on the light.

The negative-phase signal electrode 14-5 is inserted into the second optical path 12-5.

The negative-phase signal electrode 14-5 superimposes a DC bias, which is for the wavelength of the incident light, on the light transmitted by the second optical path 12-5.

At the time of initial setting of the fifth Mach-Zehnder interferometer 4-5, the negative-phase signal electrode 14-5 superimposes only the DC bias on the light and does not superimpose the modulation signal on the light.

During actual operation after the initial setting of the fifth Mach-Zehnder interferometer 4-5 is completed, the negative-phase signal electrode 14-5 superimposes both the DC bias and the modulation signal on the light.

The phase adjustment electrode 15-5 is inserted into the first optical path 11-5.

The phase adjustment electrode 15-5 superimposes the phase bias I_{φ5}(t), which is outputted from the phase-bias search unit 62, on the light transmitted by the first optical path 11-5.

The first output port 17-5 is a port for emitting the composite light to the photodetector 21-5.

The second output port 18-5 is a port for emitting light having a phase opposite to that of the composite light.

In the Mach-Zehnder interference device 2 illustrated in FIG. 12, light emitted from the second output port 18-5 is not used.

The sixth Mach-Zehnder interferometer 4-6 includes a first optical path 11-6, a second optical path 12-6, a positive-phase signal electrode 13-6, a negative-phase signal electrode 14-6, a phase adjustment electrode 15-6, a first output port 17-6 and a second output port 18-6.

Moreover, the sixth Mach-Zehnder interferometer 4-6 has a branch point 10-6, which divides incident light into two light beams, and a coupling point 16-6, which combines the two divided light beams.

The sixth Mach-Zehnder interferometer 4-6 divides incident light into two light beams at the branch point 10-6, combines the two divided light beams at the coupling point 16-6, and emits the composite light of the two light beams to the photodetector 21-6.

The positive-phase signal electrode 13-6 is inserted into the first optical path 11-6.

The positive-phase signal electrode 13-6 superimposes a DC bias, which is for the wavelength of the incident light, on the light transmitted by the first optical path 11-6.

At the time of initial setting of the sixth Mach-Zehnder interferometer 4-6, the positive-phase signal electrode 13-6 superimposes only the DC bias on the light and does not superimpose the modulation signal on the light.

During actual operation after the initial setting of the sixth Mach-Zehnder interferometer 4-6 is completed, the positive-phase signal electrode 13-6 superimposes both the DC bias and the modulation signal on the light.

The negative-phase signal electrode 14-6 is inserted into the second optical path 12-6.

The negative-phase signal electrode 14-6 superimposes a DC bias, which is for the wavelength of the incident light, on the light transmitted by the second optical path 12-6.

At the time of initial setting of the sixth Mach-Zehnder interferometer 4-6, the negative-phase signal electrode 14-6 superimposes only the DC bias on the light and does not superimpose the modulation signal on the light.

During actual operation after the initial setting of the sixth Mach-Zehnder interferometer 4-6 is completed, the negative-phase signal electrode 14-6 superimposes both the DC bias and the modulation signal on the light.

The phase adjustment electrode 15-6 is inserted into the first optical path 11-6.

The phase adjustment electrode 15-6 superimposes the phase bias I_{φ6}(t), which is outputted from the phase-bias search unit 50, on the light transmitted by the first optical path 11-6.

The first output port 17-6 is a port for emitting the composite light to the photodetector 21-6.

The second output port 18-6 is a port for emitting light having a phase opposite to that of the composite light.

In the Mach-Zehnder interference device 2 illustrated in FIG. 12, light emitted from the second output port 18-6 is not used.

The photodetector 21-5 is implemented by, for example, a photodiode.

The photodetector 21-5 is connected to the first output port 17-5 of the fifth Mach-Zehnder interferometer 4-5.

The photodetector 21-5 detects the composite light emitted from the first output port 17-5 and outputs a fifth intensity signal I_{PD5}(t), which indicates the intensity of the detected composite light, to the phase-bias search unit 62.

The photodetector 21-5 outputs the detected composite light to the first optical path 11-4.

The photodetector 21-6 is implemented by, for example, a photodiode.

The photodetector 21-6 is connected to the first output port 17-6 of the sixth Mach-Zehnder interferometer 4-6.

The photodetector 21-6 detects the composite light emitted from the first output port 17-6 and outputs a sixth intensity signal I_{PD6}(t), which indicates the intensity of the detected composite light, to the phase-bias search unit 62.

Moreover, the photodetector 21-6 outputs the detected composite light to the phase adjustment electrode 15-4.

The photodetector 21-4 is implemented by, for example, a photodiode.

The photodetector 21-4 is connected to the first output port 17-4 of the fourth Mach-Zehnder interferometer 4-4.

The photodetector 21-4 detects the composite light emitted from the first output port 17-4 and outputs a fourth intensity signal I_{PD4}(t), which indicates the intensity of the detected composite light, to the phase-bias search unit 62.

The photodetector 21-4 also outputs the detected composite light to the outside as emission light.

While adjusting the phase bias I_{φ2}(t) injected into the first optical path 11-2 of the second Mach-Zehnder interferometer 4-2, the phase-bias search unit 62 searches for and obtains the phase bias I_{φ2}(t)ₘᵢₙ when the second intensity signal I_{PD2}(t) outputted from the photodetector 21-2 has the local minimum value.

The phase-bias search unit 62 causes a control unit 63 to record a set of the obtained phase bias I_{φ2}(t)ₘᵢₙ and the wavelength λₙ of the incident light.

While adjusting the phase bias I_{φ3}(t) injected into the first optical path 11-3 of the third Mach-Zehnder interferometer 4-3, the phase-bias search unit 62 searches for and obtains the phase bias I_{φ3}(t)ₘᵢₙ when the third intensity signal I_{PD3}(t) outputted from the photodetector 21-3 has the local minimum value.

The phase-bias search unit 62 causes the control unit 63 to record a set of the obtained phase bias I_{φ3}(t)ₘᵢₙ and the wavelength λₙ of the incident light.

While adjusting the phase bias I_{φ1}(t) injected into the second optical path 12-1 of the first Mach-Zehnder interferometer 4-1, the phase-bias search unit 62 searches for and obtains the phase bias I_{φ1}(t)_{mid} which is half the sum of the phase bias I_{φ1}(t)ₘᵢₙ and the phase bias I_{φ1}(t)ₘₐₓ. The phase bias I_{φ1}(t)ₘᵢₙ is a phase bias when the first intensity signal I_{PD1}(t) outputted from the photodetector 21-1 has the local minimum value, and the phase bias I_{φ1}(t)ₘₐₓ is a phase bias when the first intensity signal I_{PD1}(t) has the local I_{φ1}(t)ₘₐₓ maximum value.

The phase-bias search unit 62 causes the control unit 63 to record a set of the obtained phase bias I_{φ1}(t)_{mid} and the wavelength λₙ of the incident light.

While adjusting the phase bias I_{φ5}(t) injected into the first optical path 11-5 of the fifth Mach-Zehnder interferometer 4-5, the phase-bias search unit 62 searches for and obtains the phase bias I_{φ5}(t)ₘᵢₙ when the fifth intensity signal I_{PD5}(t) outputted from the photodetector 21-5 has the local minimum value.

The phase-bias search unit 62 causes the control unit 63 to record a set of the obtained phase bias I_{φ5}(t)ₘᵢₙ and the wavelength λₙ of the incident light.

While adjusting the phase bias I_{φ6}(t) injected into the first optical path 11-6 of the sixth Mach-Zehnder interferometer 4-6, the phase-bias search unit 62 searches for and obtains the phase bias I_{φ6}(t)ₘᵢₙ when the sixth intensity signal I_{PD6}(t) outputted from the photodetector 21-6 has the local minimum value.

The phase-bias search unit 62 causes the control unit 63 to record a set of the obtained phase bias I_{φ6}(t)ₘᵢₙ and the wavelength λₙ of the incident light.

While adjusting the phase bias I_{φ4}(t) injected into the second optical path 12-4 of the fourth Mach-Zehnder interferometer 4-4, the phase-bias search unit 62 searches for and obtains the phase bias I_{φ4}(t)_{mid} which is half the sum of the phase bias I_{φ4}(t)ₘᵢₙ and the phase bias I_{φ4}(t)ₘₐₓ. The phase bias I_{φ4}(t)ₘᵢₙ is a phase bias when the fourth intensity signal I_{PD4}(t) outputted from the photodetector 21-4 has the local minimum value, and the phase bias I_{φ4}(t)ₘₐₓ is a phase bias when the fourth intensity signal I_{PD4}(t) has the local maximum value.

The phase-bias search unit 62 causes the control unit 63 to record a set of the obtained phase bias I_{φ4}(t)_{mid} and the wavelength λₙ of the incident light.

The control unit 63 records a set of the wavelength λₙ of the incident light, the phase bias I_{φ2}(t)ₘᵢₙ, the phase bias I_{φ3}(t)ₘᵢₙ, the phase bias I_{φ1}(t)ₘᵢₙ, the phase bias I_{φ5}(t)ₘᵢₙ, the phase bias I_{φ6}(t)ₘᵢₙ and the phase bias I_{φ4}(t)_{mid}.

During actual operation of the first Mach-Zehnder interferometer 4-1, the control unit 63 outputs the phase bias I_{φ1}(t)_{mid}, which is for the wavelength λₙ, to the phase-bias search unit 62.

During actual operation of the second Mach-Zehnder interferometer 4-2, the control unit 63 outputs the phase bias I_{φ2}(t)ₘᵢₙ, which is for the wavelength λₙ, to the phase-bias search unit 62.

During actual operation of the third Mach-Zehnder interferometer 4-3, the control unit 63 outputs the phase bias I_{φ3}(t)ₘᵢₙ, which is for the wavelength λₙ, to the phase-bias search unit 62.

During actual operation of the fourth Mach-Zehnder interferometer 4-4, the control unit 63 outputs the phase bias I_{φ4}(t)_{mid}, which is for the wavelength λₙ, to the phase-bias search unit 62.

During actual operation of the fifth Mach-Zehnder interferometer 4-5, the control unit 63 outputs the phase bias I_{φ5}(t)ₘᵢₙ, which is for the wavelength λₙ, to the phase-bias search unit 62.

During actual operation of the sixth Mach-Zehnder interferometer 4-6, the control unit 63 outputs the phase bias I_{φ6}(t)ₘᵢₙ, which is for the wavelength λₙ, to the phase-bias search unit 62.

Next, the operation of the Mach-Zehnder interference device 2 illustrated in FIG. 12 will be described.

First, the operation at the time of initial setting will be described.

The operation of the fourth Mach-Zehnder interferometer 4-4 is similar to the operation of the first Mach-Zehnder interferometer 4-1, and the operation of the fifth Mach-Zehnder interferometer 4-5 is similar to the operation of the second Mach-Zehnder interferometer 4-2.

Moreover, the operation of the sixth Mach-Zehnder interferometer 4-6 is similar to the operation of the third Mach-Zehnder interferometer 4-3.

Therefore, the details of the operations of the fourth Mach-Zehnder interferometer 4-4, the fifth Mach-Zehnder interferometer 4-5 and the sixth Mach-Zehnder interferometer 4-6 will be omitted.

Similar to the phase-bias search unit 50 shown in FIG. 11, while adjusting the phase bias I_{φ2}(t) injected into the first optical path 11-2 of the second Mach-Zehnder interferometer 4-2, the phase-bias search unit 62 searches for and obtains the phase bias I_{φ2}(t)ₘᵢₙ when the second intensity signal I_{PD2}(t) outputted from the photodetector 21-2 has the local minimum value.

The phase-bias search unit 62 causes the control unit 63 to record a set of the obtained phase bias I_{φ2}(t)ₘᵢₙ and the wavelength λₙ of the incident light.

Similar to the phase-bias search unit 50 shown in FIG. 11, while adjusting the phase bias I_{φ3}(t) injected into the first optical path 11-3 of the third Mach-Zehnder interferometer 4-3, the phase-bias search unit 62 searches for and obtains the phase bias I_{φ3}(t)ₘᵢₙ when the third intensity signal I_{PD3}(t) outputted from the photodetector 21-3 has the local minimum value.

The phase-bias search unit 62 causes the control unit 63 to record a set of the obtained phase bias I_{φ3}(t)ₘᵢₙ and the wavelength λₙ of the incident light.

Similar to the phase-bias search unit 50 shown in FIG. 11, while adjusting the phase bias I_{φ1}(t) injected into the second optical path 12-1 of the first Mach-Zehnder interferometer 4-1, the phase-bias search unit 62 searches for and obtains the phase bias I_{φ1}(t)ₘᵢₙ when the first intensity signal I_{PD1}(t) outputted from the photodetector 21-1 has the local minimum value.

The phase-bias search unit 62 temporarily saves the phase bias I_{φ1}(t)ₘᵢₙ when the first intensity signal I_{PD1}(t) has the local minimum value.

While adjusting the phase bias I_{φ1}(t) injected into the second optical path 12-1, the phase-bias search unit 62 searches for and obtains the phase bias I_{φ1}(t)ₘₐₓ when the first intensity signal I_{PD1}(t) outputted from the photodetector 21-1 has the local maximum value.

The phase-bias search unit 62 temporarily saves the phase bias I_{φ1}(t)ₘₐₓ when the first intensity signal I_{PD1}(t) has the local maximum value.

As expressed in the formula (8), the phase-bias search unit 62 calculates the phase bias I_{φ1}(t)_{mid}, which is half the sum of the temporarily saved phase bias I_{φ1}(t)ₘᵢₙ and the temporarily saved phase bias I_{φ1}(t)ₘₐₓ.

The phase-bias search unit 62 causes the control unit 63 to record a set of the calculated phase bias I_{φ1}(t)_{mid} and the wavelength λₙ of the incident light.

While adjusting the phase bias I_{φ5}(t) injected into the first optical path 11-5 of the fifth Mach-Zehnder interferometer 4-5, the phase-bias search unit 62 searches for and obtains the phase bias I_{φ5}(t)ₘᵢₙ when the fifth intensity signal I_{PD5}(t) outputted from the photodetector 21-5 has the local minimum value.

The phase-bias search unit 62 causes the control unit 63 to record a set of the obtained phase bias I_{φ5}(t)ₘᵢₙ and the wavelength λₙ of the incident light.

While adjusting the phase bias I_{φ6}(t) injected into the first optical path 11-6 of the sixth Mach-Zehnder interferometer 4-6, the phase-bias search unit 62 searches for and obtains the phase bias I_{φ6}(t)ₘᵢₙ when the sixth intensity signal I_{PD6}(t) outputted from the photodetector 21-6 has the local minimum value.

The phase-bias search unit 62 causes the control unit 63 to record a set of the obtained phase bias I_{φ6}(t)ₘᵢₙ and the wavelength λₙ of the incident light.

While adjusting the phase bias I_{φ4}(t) injected into the second optical path 12-4 of the fourth Mach-Zehnder interferometer 4-4, the phase-bias search unit 62 searches for and obtains the phase bias I_{φ4}(t)ₘᵢₙ when the fourth intensity signal I_{PD4}(t) outputted from the photodetector 21-4 has the local minimum value.

The phase-bias search unit 62 temporarily saves the phase bias I_{φ4}(t)ₘᵢₙ when the fourth intensity signal I_{PD4}(t) has the local minimum value.

While adjusting the phase bias I_{φ4}(t) injected into the second optical path 12-4, the phase-bias search unit 62 searches for and obtains the phase bias I_{φ4}(t)ₘₐₓ when the fourth intensity signal I_{PD4}(t) outputted from the photodetector 21-4 has the local maximum value.

The phase-bias search unit 62 temporarily saves the phase bias I_{φ4}(t)ₘₐₓ when the fourth intensity signal I_{PD4}(t) has the local maximum value.

The phase-bias search unit 62 calculates the phase bias I_{φ4}(t)_{mid}, which is half the sum of the temporarily saved phase bias I_{φ4}(t)ₘᵢₙ and the temporarily saved phase bias I_{φ4}(t)ₘₐₓ as expressed in the following formula (9).

$${{I}_{∅4} ( t )}_{mid} = \frac{{{I}_{∅4} ( t )}_{min} + {{I}_{∅4} ( t )}_{max}}{2} \qquad ( 9 )$$

The phase-bias search unit 62 causes the control unit 63 to record a set of the calculated phase bias I_{φ4}(t)_{mid} and the wavelength λₙ of the incident light.

Next, the operation during actual operation will be described.

In the Mach-Zehnder interference device 2 shown in FIG. 12, suppose that wavelength information indicating a wavelength λₙ to be used in actual operation among the N wavelengths λ₁ to λ_{N} is applied to the light source 1 and the control unit 63.

The light source 1 emits continuous light having a wavelength λₙ indicated by the wavelength information to the optical fiber 3.

A DC bias for the wavelength λₙ of the continuous light emitted from the light source 1 is applied to each of the positive-phase signal electrodes 13-2 and 13-3 and the negative-phase signal electrodes 14-2 and 14-3.

When the DC bias is applied, the positive-phase signal electrode 13-2 superimposes both the DC bias and the modulation signal on the light transmitted by the first optical path 11-2.

When the DC bias is applied, the positive-phase signal electrode 13-3 superimposes both the DC bias and the modulation signal on the light transmitted by the first optical path 11-3.

When the DC bias is applied, the negative-phase signal electrode 14-2 superimposes both the DC bias and the modulation signal on the light transmitted by the second optical path 12-2.

When the DC bias is applied, the negative-phase signal electrode 14-3 superimposes both the DC bias and the modulation signal on the light transmitted by the second optical path 12-3.

A DC bias for the wavelength λₙ of the continuous light emitted from the light source 1 is applied to each of the positive-phase signal electrodes 13-5 and 13-6 and the negative-phase signal electrodes 14-5 and 14-6.

When the DC bias is applied, the positive-phase signal electrode 13-5 superimposes both the DC bias and the modulation signal on the light transmitted by the first optical path 11-5.

When the DC bias is applied, the positive-phase signal electrode 13-6 superimposes both the DC bias and the modulation signal on the light transmitted by the first optical path 11-6.

When the DC bias is applied, the negative-phase signal electrode 14-5 superimposes both the DC bias and the modulation signal on the light transmitted by the second optical path 12-5.

When the DC bias is applied, the negative-phase signal electrode 14-6 superimposes both the DC bias and the modulation signal on the light transmitted by the second optical path 12-6.

The control unit 63 acquires the phase bias I_{φ1}(t)_{mid} for the wavelength λₙ indicated by the wavelength information, the phase bias I_{φ2}(t)ₘᵢₙ for the wavelength λₙ, and the phase bias I_{φ3}(t)ₘᵢₙ for the wavelength λₙ from among the phase biases for the N wavelengths λ₁ to λ_{N} recorded at the time of initial setting.

The control unit 63 outputs the phase bias I_{φ1}(t)_{mid}, the phase bias I_{φ2}(t)ₘᵢₙ and the phase bias I_{φ3}(t)ₘᵢₙ to the phase-bias search unit 62.

The phase-bias search unit 62 outputs the phase bias I_{φ2}(t)ₘᵢₙ outputted from the control unit 63 to the phase adjustment electrode 15-2 and outputs the phase bias I_{φ3}(t)ₘᵢₙ outputted from the control unit 63 to the phase adjustment electrode 15-3.

Moreover, the phase-bias search unit 62 outputs the phase bias I_{φ1}(t)_{mid}, which is outputted from the control unit 63, to the phase adjustment electrode 15-1.

The control unit 63 acquires the phase bias I_{φ4}(t)_{mid} for the wavelength λₙ indicated by the wavelength information, the phase bias I_{φ5}(t)ₘᵢₙ for the wavelength λₙ, and the phase bias I_{φ6}(t)ₘᵢₙ for the wavelength λₙ from among the phase biases for the N wavelengths λ₁ to λ_{N} recorded at the time of initial setting.

The control unit 63 outputs the phase bias I_{φ4}(t)_{mid}, the phase bias I_{φ5}(t)ₘᵢₙ and the phase bias I_{φ6}(t)ₘᵢₙ to the phase-bias search unit 62.

The phase-bias search unit 62 outputs the phase bias I_{φ5}(t)ₘᵢₙ outputted from the control unit 63 to the phase adjustment electrode 15-5 and outputs the phase bias I_{φ6}(t)ₘᵢₙ outputted from the control unit 63 to the phase adjustment electrode 15-6.

Moreover, the phase-bias search unit 62 outputs the phase bias I_{φ4}(t)_{mid}, which is outputted from the control unit 63, to the phase adjustment electrode 15-4.

The phase adjustment electrode 15-2 superimposes the phase bias I_{φ2}(t)ₘᵢₙ, which is outputted from the phase-bias search unit 62, on the light transmitted by the first optical path 11-2.

The photodetector 21-2 detects the composite light emitted from the first output port 17-2 of the second Mach-Zehnder interferometer 4-2 and outputs the detected composite light to the coupling point 16-1.

The phase adjustment electrode 15-3 superimposes the phase bias I_{φ3}(t)ₘᵢₙ, which is outputted from the phase-bias search unit 62, on the light transmitted by the first optical path 11-3.

The photodetector 21-3 detects the composite light emitted from the first output port 17-3 of the third Mach-Zehnder interferometer 4-3 and outputs the detected composite light to the phase adjustment electrode 15-1.

The phase adjustment electrode 15-1 superimposes the phase bias I_{φ1}(t)_{mid}, which is outputted from the phase-bias search unit 62, on the light outputted from the photodetector 21-3.

The photodetector 21-1 detects the composite light emitted from the first output port 17-1 of the first Mach-Zehnder interferometer 4-1 and outputs the detected composite light to the outside as emission light.

The phase adjustment electrode 15-5 superimposes the phase bias I_{φ5}(t)ₘᵢₙ, which is outputted from the phase-bias search unit 62, on the light transmitted by the first optical path 11-5.

The photodetector 21-5 detects the composite light emitted from the first output port 17-5 of the fifth Mach-Zehnder interferometer 4-5 and outputs the detected composite light to the coupling point 16-4.

The phase adjustment electrode 15-6 superimposes the phase bias I_{φ6}(t)ₘᵢₙ, which is outputted from the phase-bias search unit 62, on the light transmitted by the first optical path 11-6.

The photodetector 21-6 detects the composite light emitted from the first output port 17-6 of the sixth Mach-Zehnder interferometer 4-6 and outputs the detected composite light to the phase adjustment electrode 15-4.

The phase adjustment electrode 15-4 superimposes the phase bias I_{φ4}(t)_{mid}, which is outputted from the phase-bias search unit 62, on the light outputted from the photodetector 21-6.

The photodetector 21-4 detects the composite light emitted from the first output port 17-4 of the fourth Mach-Zehnder interferometer 4-4 and outputs the detected composite light to the outside as emission light.

In the Mach-Zehnder interference device 2 shown in FIG. 12, the photodetector 21-2 detects the composite light emitted from the first output port 17-2 of the second Mach-Zehnder interferometer 4-2, the photodetector 21-3 detects the composite light emitted from the first output port 17-3 of the third Mach-Zehnder interferometer 4-3, and the photodetector 21-1 detects the composite light emitted from the first output port 17-1 of the first Mach-Zehnder interferometer 4-1.

Moreover, the photodetector 21-5 detects the composite light emitted from the first output port 17-5 of the fifth Mach-Zehnder interferometer 4-5, the photodetector 21-6 detects the composite light emitted from the first output port 17-6 of the sixth Mach-Zehnder interferometer 4-6, and the photodetector 21-4 detects the composite light emitted from the first output port 17-4 of the fourth Mach-Zehnder interferometer 4-4.

However, these are merely examples. The photodetector 21-2 may detect the composite light emitted from the second output port 18-2 of the second Mach-Zehnder interferometer 4-2, the photodetector 21-3 may detect the composite light emitted from the second output port 18-3 of the third Mach-Zehnder interferometer 4-3, and the photodetector 21-1 may detect the composite light emitted from the second output port 18-1 of the first Mach-Zehnder interferometer 4-1.

Furthermore, the photodetector 21-5 may detect the composite light emitted from the second output port 18-5 of the fifth Mach-Zehnder interferometer 4-5, the photodetector 21-6 may detect the composite light emitted from the second output port 18-6 of the sixth Mach-Zehnder interferometer 4-6, and the photodetector 21-4 may detect the composite light emitted from the second output port 18-4 of the fourth Mach-Zehnder interferometer 4-4.

In this case, the phase-bias search unit 62 searches for and obtains the phase bias I_{φ2}(t)ₘₐₓ when the second intensity signal I_{PD2}(t) outputted from the photodetector 21-2 has the local maximum value. Furthermore, the phase-bias search unit 62 searches for and obtains the phase bias I_{φ3}(t)ₘₐₓ when the third intensity signal I_{PD3}(t) outputted from the photodetector 21-3 has the local maximum value. Moreover, the phase-bias search unit 62 searches for and obtains the phase bias I_{φ1}(t)_{mid} which is half the sum of the phase bias I_{φ1}(t)ₘᵢₙ and the phase bias I_{φ1}(t)ₘₐₓ. The phase bias I_{φ1}(t)ₘᵢₙ is a phase bias when the first intensity signal I_{PD1}(t) outputted from the photodetector 21-1 has the local minimum value, and the phase bias I_{φ1}(t)ₘₐₓ is a phase bias when the first intensity signal I_{PD1}(t) has the local maximum value.

Furthermore, the phase-bias search unit 62 searches for and obtains the phase bias I_{φ5}(t)ₘₐₓ when the fifth intensity signal I_{PD5}(t) outputted from the photodetector 21-5 has the local maximum value. Moreover, the phase-bias search unit 62 searches for and obtains the phase bias I_{φ6}(t)ₘₐₓ when the sixth intensity signal I_{PD6}(t) outputted from the photodetector 21-6 has the local maximum value. Furthermore, the phase-bias search unit 62 searches for and obtains the phase bias I_{φ4}(t)_{mid} which is half the sum of the phase bias I_{φ4}(t)ₘᵢₙ and the phase bias I_{φ4}(t)ₘₐₓ. The phase bias I_{φ4}(t)ₘᵢₙ is a phase bias when the fourth intensity signal I_{PD4}(t) outputted from the photodetector 21-4 has the local minimum value, and the phase bias I_{φ4}(t)ₘₐₓ is a phase bias when the fourth intensity signal I_{PD4}(t) has the local maximum value.

As described above, even in the Mach-Zehnder interference device 2 which performs DP-QPSK, the phase bias for the wavelength of the incident light can be superimposed on the light even if the wavelength of the incident light changes, as in the Mach-Zehnder interference device 2 shown in FIG. 1.

Note that, in the scope of the present invention, the present invention of this application allows free combinations of each embodiment, modification of any constituents of each embodiment, or omission of any constituents in each embodiment.

### INDUSTRIAL APPLICABILITY

The present invention is suitable for an optical modulation control device and a Mach-Zehnder interference device, which search for a phase bias.

### REFERENCE SIGNS LIST

1: light source,
2: Mach-Zehnder interference device,
3: optical fiber,
4: Mach-Zehnder interferometer,
4-1: first Mach-Zehnder interferometer,
4-2: second Mach-Zehnder interferometer,
4-3: third Mach-Zehnder interferometer,
4-4: fourth Mach-Zehnder interferometer,
4-5: fifth Mach-Zehnder interferometer,
4-6: sixth Mach-Zehnder interferometer,
5: optical modulation control device,
10, 10-1, 10-2, 10-3, 10-4, 10-5, 10-6: branch point,
11, 11-1, 11-2, 11-3, 11-4, 11-5, 11-6: first optical path,
12, 12-1, 12-2, 12-3, 12-4, 12-5, 12-6: second optical path,
13, 13-1, 13-2, 13-3, 13-4, 13-5, 13-6: positive-phase signal electrode,
14, 14-1, 14-2, 14-3, 14-4, 14-5, 14-6: negative-phase signal electrode,
15, 15a, 15b, 15-1, 15-2, 15-3, 15-4, 15-5, 15-6: phase adjustment electrode,
16, 16-1, 16-2, 16-3, 16-4, 16-5, 16-6: coupling point,
17, 17-1, 17-2, 17-3, 17-4, 17-5, 17-6: first output port,
18, 18-1, 18-2, 18-3, 18-4, 18-5, 18-6: second output port,
21, 21-1, 21-2, 21-3, 21-4, 21-5, 21-6: photodetector,
22: phase-bias search unit (phase-bias searcher),
23: delayer,
24: amplifier,
25: comparator,
25a: input terminal,
25b: inverting input terminal,
26: phase-bias adjustment unit (phase-bias adjuster),
27: phase-bias recording unit (phase-bias recorder),
28: control unit,
29: photodetector,
31: phase-bias adjustment circuit,
32: phase-bias recording circuit,
33: control circuit,
41: memory,
42: processor,
50: phase-bias search unit (phase-bias searcher),
51: control unit,
61: splitter,
62: phase-bias search unit (phase-bias searcher), and
63: control unit

What is claimed is:

1. An optical modulation control device, comprising:
a photodetector to detect light emitted from a Mach-Zehnder interferometer and output an intensity signal that indicates intensity of the light; and
a phase-bias searcher to search for and obtain a phase bias when the intensity signal outputted from the photodetector has a local minimum value or a phase bias when the intensity signal has a local maximum value, while adjusting a phase bias injected into an optical path inside the Mach-Zehnder interferometer, and record a set of the obtained phase bias and a wavelength of the light,
wherein the phase-bias searcher comprises:
a phase-bias adjuster to adjust a phase bias injected into the optical path inside the Mach-Zehnder interferometer;
a delayer to keep the intensity signal outputted from the photodetector for a delay time and then output the intensity signal;
an amplifier to amplify the intensity signal outputted from the photodetector and output the intensity signal amplified;
a comparator to output a differential signal indicating a difference between the intensity signal outputted from the delayer and the intensity signal outputted from the amplifier; and
a phase-bias recorder to search for and obtain one or more phase biases when an absolute value of the differential signal outputted from the comparator is smaller than a threshold from among the phase biases injected into the optical path, search for and obtain a smallest intensity signal or a largest intensity signal among intensity signals for the obtained one or more phase biases among the intensity signals outputted from the photodetector, and record a set of a phase bias for the obtained smallest intensity signal and a wavelength of the light or a set of a phase bias for the obtained largest intensity signal and the wavelength of the light.

2. The optical modulation control device according to claim 1, wherein the phase-bias adjuster adjusts an amplification factor of the intensity signal in the amplifier in accordance with the differential signal outputted from the comparator.

3. The optical modulation control device according to claim 1, wherein the Mach-Zehnder interferometer divides incident light into two beams of light and emits composite light of the two beams of the light to the photodetector,
the Mach-Zehnder interferometer has two optical paths as the inside paths through which the respective two beams of the light are transmitted, and
the phase-bias adjuster adjusts, in accordance with the differential signal outputted from the comparator, a phase bias injected into one of the two optical paths.

4. The optical modulation control device according to claim 1, wherein the Mach-Zehnder interferometer divides incident light into two beams of light and emits composite light of the two beams of the light to the photodetector;
the Mach-Zehnder interferometer has two optical paths as the inside paths through which the respective two beams of the light are transmitted;
the phase-bias adjuster adjusts, in accordance with the differential signal outputted from the comparator, a phase bias injected into each of the two optical paths.

5. The optical modulation control device according to claim 1, wherein the Mach-Zehnder interferometer has a first output port to emit light and a second output port to emit light having a phase opposite to that of the light emitted from the first output port;
the phase-bias searcher searches for and obtains a phase bias when the intensity signal outputted from the photodetector has the local minimum value if the light detected by the photodetector is the light emitted from the first output port; and
the phase-bias searcher searches for and obtains a phase bias when the intensity signal outputted from the photodetector has the local maximum value if the light detected by the photodetector is the light emitted from the second output port.

6. The optical modulation control device according to claim 2, wherein the Mach-Zehnder interferometer has a first output port to emit light and a second output port to emit light having a phase opposite to that of the light emitted from the first output port;
the phase-bias searcher searches for and obtains a phase bias when the intensity signal outputted from the photodetector has the local minimum value if the light detected by the photodetector is the light emitted from the first output port; and
the phase-bias searcher searches for and obtains a phase bias when the intensity signal outputted from the photodetector has the local maximum value if the light detected by the photodetector is the light emitted from the second output port.

7. The optical modulation control device according to claim 3, wherein the Mach-Zehnder interferometer has a first output port to emit light and a second output port to emit light having a phase opposite to that of the light emitted from the first output port;
the phase-bias searcher searches for and obtains a phase bias when the intensity signal outputted from the photodetector has the local minimum value if the light detected by the photodetector is the light emitted from the first output port; and
the phase-bias searcher searches for and obtains a phase bias when the intensity signal outputted from the photodetector has the local maximum value if the light detected by the photodetector is the light emitted from the second output port.

8. The optical modulation control device according to claim 4, wherein the Mach-Zehnder interferometer has a first output port to emit light and a second output port to emit light having a phase opposite to that of the light emitted from the first output port;
the phase-bias searcher searches for and obtains a phase bias when the intensity signal outputted from the photodetector has the local minimum value if the light detected by the photodetector is the light emitted from the first output port; and
the phase-bias searcher searches for and obtains a phase bias when the intensity signal outputted from the photodetector has the local maximum value if the light detected by the photodetector is the light emitted from the second output port.

9. The optical modulation control device according to claim 1, wherein the phase-bias searcher searches for and obtains a phase bias when the intensity signal outputted from the photodetector has a local minimum value, a phase bias when the intensity signal has a local maximum value while adjusting a phase bias injected into an optical path inside the Mach-Zehnder interferometer, and records a set of the phase bias when the intensity signal has the local minimum value, the phase bias when the intensity signal has the local maximum value and the wavelength of the light.

10. The optical modulation control device according to claim 2, wherein the phase-bias searcher searches for and obtains a phase bias when the intensity signal outputted from the photodetector has a local minimum value, a phase bias when the intensity signal has a local maximum value while adjusting a phase bias injected into an optical path inside the Mach-Zehnder interferometer, and records a set of the phase bias when the intensity signal has the local minimum value, the phase bias when the intensity signal has the local maximum value and the wavelength of the light.

11. The optical modulation control device according to claim 3, wherein the phase-bias searcher searches for and obtains a phase bias when the intensity signal outputted from the photodetector has a local minimum value, a phase bias when the intensity signal has a local maximum value while adjusting a phase bias injected into an optical path inside the Mach-Zehnder interferometer, and records a set of the phase bias when the intensity signal has the local minimum value, the phase bias when the intensity signal has the local maximum value and the wavelength of the light.

12. The optical modulation control device according to claim 4, wherein the phase-bias searcher searches for and obtains a phase bias when the intensity signal outputted from the photodetector has a local minimum value, a phase bias when the intensity signal has a local maximum value while adjusting a phase bias injected into an optical path inside the Mach-Zehnder interferometer, and records a set of the phase bias when the intensity signal has the local minimum value, the phase bias when the intensity signal has the local maximum value and the wavelength of the light.

13. The optical modulation control device according to claim 5, wherein the phase-bias searcher searches for and obtains a phase bias when the intensity signal outputted from the photodetector has a local minimum value, a phase bias when the intensity signal has a local maximum value while adjusting a phase bias injected into an optical path inside the Mach-Zehnder interferometer, and records a set of the phase bias when the intensity signal has the local minimum value, the phase bias when the intensity signal has the local maximum value and the wavelength of the light.

14. An optical modulation control device, comprising:
a photodetector to detect light emitted from a Mach-Zehnder interferometer and output an intensity signal that indicates intensity of the light; and
a phase-bias searcher to search for and obtain a phase bias when the intensity signal outputted from the photodetector has a local minimum value or a phase bias when the intensity signal has a local maximum value, while adjusting a phase bias injected into an optical path inside the Mach-Zehnder interferometer, and record a set of the obtained phase bias and a wavelength of the light,
wherein the Mach-Zehnder interferometer comprises:
a first Mach-Zehnder interferometer having two optical paths which divide incident light into two light beams and transmit the respective two light beams;
a second Mach-Zehnder interferometer inserted into one optical path of the two optical paths of the first Mach-Zehnder interferometer; and
a third Mach-Zehnder interferometer inserted into the other optical path of the two optical paths of the first Mach-Zehnder interferometer,
the photodetector detects the light emitted from each of the first Mach-Zehnder interferometer, the second Mach-Zehnder interferometer and the third Mach-Zehnder interferometer,
the phase-bias searcher searches for and obtains a phase bias when a second intensity signal indicating intensity of the light emitted from the second Mach-Zehnder interferometer has the local minimum value or a phase bias when the second intensity signal has the local maximum value from among intensity signals outputted from the photodetector while adjusting a phase bias injected into an optical path inside the second Mach-Zehnder interferometer, and records a set of a wavelength of the light and the phase bias when the second intensity signal has the local minimum value or the local maximum value,
the phase-bias searcher searches for and obtains a phase bias when a third intensity signal indicating intensity of light emitted from the third Mach-Zehnder interferometer has the local minimum value or a phase bias when the third intensity signal has the local maximum value from among intensity signals outputted from the photodetector while adjusting a phase bias injected into the optical path inside the third Mach-Zehnder interferometer, and records a set of a wavelength of the light and the phase bias when the third intensity signal has the local minimum value or the local maximum value, and
the phase-bias searcher searches for and obtains a phase bias which is half a sum of a phase bias when a first intensity signal indicating intensity of light emitted from the first Mach-Zehnder interferometer has the local minimum value and a phase bias when the first intensity signal has the local maximum value from among intensity signals outputted from the photodetector while adjusting the phase bias injected into the optical path inside the first Mach-Zehnder interferometer, and records a set of a wavelength of the light and half the phase biases.

15. An optical modulation control device, comprising:
a photodetector to detect light emitted from a Mach-Zehnder interferometer and output an intensity signal that indicates intensity of the light; and
a phase-bias searcher to search for and obtain a phase bias when the intensity signal outputted from the photodetector has a local minimum value or a phase bias when the intensity signal has a local maximum value, while adjusting a phase bias injected into an optical path inside the Mach-Zehnder interferometer, and record a set of the obtained phase bias and a wavelength of the light,
wherein the Mach-Zehnder interferometer comprises:
a first Mach-Zehnder interferometer having two optical paths which divide a first polarized wave of incident light into two light beams and transmit the respective two first polarized light beams;
a second Mach-Zehnder interferometer inserted into one optical path of the two optical paths of the first Mach-Zehnder interferometer;
a third Mach-Zehnder interferometer inserted into the other optical path of the two optical paths of the first Mach-Zehnder interferometer;
a fourth Mach-Zehnder interferometer having two optical paths which divide a second polarized wave of incident light into two light beams and transmit the respective two second polarized light beams;
a fifth Mach-Zehnder interferometer inserted into one optical path of the two optical paths of the fourth Mach-Zehnder interferometer; and
a sixth Mach-Zehnder interferometer inserted into the other optical path of the two optical paths of the fourth Mach-Zehnder interferometer;
the photodetector detects the light emitted from each of the first Mach-Zehnder interferometer, the second Mach-Zehnder interferometer, the third Mach-Zehnder interferometer, the fourth Mach-Zehnder interferometer, the fifth Mach-Zehnder interferometer and the sixth Mach-Zehnder interferometer,
the phase-bias searcher searches for and obtains a phase bias when a second intensity signal indicating intensity of light emitted from the second Mach-Zehnder interferometer has the local minimum value or a phase bias when the second intensity signal has the local maximum value from among intensity signals outputted from the photodetector while adjusting a phase bias injected into the optical path inside the second Mach-Zehnder interferometer, and records a set of a wavelength of the light and the phase bias when the second intensity signal has the local minimum value or the local maximum value,
the phase-bias searcher searches for and obtains a phase bias when a third intensity signal indicating intensity of light emitted from the third Mach-Zehnder interferometer has the local minimum value or a phase bias when the third intensity signal has the local maximum value from among intensity signals outputted from the photodetector while adjusting phase bias injected into the optical path inside the third Mach-Zehnder interferometer, and records a set of a wavelength of the light and the phase bias when the third intensity signal has the local minimum value or the local maximum value,
the phase-bias searcher searches for and obtains a phase bias which is half a sum of a phase bias when a first intensity signal indicating intensity of light emitted from the first Mach-Zehnder interferometer has the local minimum value and a phase bias when the first intensity signal has the local maximum value from among intensity signals outputted from the photodetector while adjusting a phase bias injected into the optical path inside the first Mach-Zehnder interferometer, and records a set of a wavelength of the light and half the phase biases,
the phase-bias searcher searches for and obtains a phase bias when a fifth intensity signal indicating intensity of light emitted from the fifth Mach-Zehnder interferometer has the local minimum value or a phase bias when the fifth intensity signal has the local maximum value from among intensity signals outputted from the photodetector while adjusting a phase bias injected into the optical path inside the fifth Mach-Zehnder interferometer, and records a set of a wavelength of the light and the phase bias when the fifth intensity signal has the local minimum value or the local maximum value,
the phase-bias searcher searches for and obtains a phase bias when a sixth intensity signal indicating intensity of light emitted from the sixth Mach-Zehnder interferometer has the local minimum value or a phase bias when the sixth intensity signal has the local maximum value from among intensity signals outputted from the photodetector while adjusting a phase bias injected into the optical path inside the sixth Mach-Zehnder interferometer, and records a set of a wavelength of the light and the phase bias when the sixth intensity signal has the local minimum value or the local maximum value, and
the phase-bias searcher searches for and obtains a phase bias which is half a sum of a phase bias when a fourth intensity signal indicating intensity of light emitted from the fourth Mach-Zehnder interferometer has the local minimum value and a phase bias when the fourth intensity signal has the local maximum value from among intensity signals outputted from the photodetector while adjusting phase bias injected into the optical path inside the fourth Mach-Zehnder interferometer, and records a set of a wavelength of the light and half the phase biases.

16. A Mach-Zehnder interference device, comprising:
a Mach-Zehnder interferometer having an optical path which divides incident light into two light beams and transmits two divided light beams;
a photodetector to detect light emitted from the Mach-Zehnder interferometer and outputting an intensity signal that indicates intensity of the light; and
a phase-bias searcher to search for and obtain a phase bias when the intensity signal outputted from the photodetector has a local minimum value or a phase bias when the intensity signal has a local maximum value, while adjusting a phase bias injected into the optical path of the Mach-Zehnder interferometer, and record a set of the obtained phase bias and a wavelength of the light,
wherein the phase-bias searcher comprises:
a phase-bias adjuster to adjust a phase bias injected into the optical path inside the Mach-Zehnder interferometer;
a delayer to keep the intensity signal outputted from the photodetector for a delay time and then output the intensity signal;
an amplifier to amplify the intensity signal outputted from the photodetector and output the intensity signal amplified;
a comparator to output a differential signal indicating a difference between the intensity signal outputted from the delayer and the intensity signal outputted from the amplifier; and
a phase-bias recorder to search for and obtain one or more phase biases when an absolute value of the differential signal outputted from the comparator is smaller than a threshold from among the phase biases injected into the optical path, search for and obtain a smallest intensity signal or a largest intensity signal among intensity signals for the obtained one or more phase biases among the intensity signals outputted from the photodetector, and record a set of a phase bias for the obtained smallest intensity signal and a wavelength of the light or a set of a phase bias for the obtained largest intensity signal and the wavelength of the light.
